(19) United States
(12) Patent Application Publication
(10) Pub. No.: US 2026/0343256 A1
(43) Pub. Date: Oct. 29, 2026

(54) UNIFIED COMMON CHANNEL DESIGN FOR LOW BANDWIDTH AND HIGH BANDWIDTH UES

(71) Applicant: Samsung Electronics Co., Ltd., Suwon-si (KR)

(72) Inventors: Emad Nader Farag, Flanders, NJ (US); Aristides Papasakellariou, Houston, TX (US); Hongbo Si, Plano, TX (US)

(21) Appl. No.: 19/547,487

(22) Filed: Feb. 23, 2026

Related U.S. Application Data
(60) Provisional application No. 63/768,322, filed on Mar. 7, 2025.

(51) Int. Cl. H04W 24/02

(52) U.S. Cl. CPC H04W 24/02

(57) ABSTRACT

Apparatuses and methods for a unified common channel or signal design for low bandwidth and high bandwidth user equipment (UEs). A method of operating a UE includes receiving a signal including a first part and a second part and selecting, based on a type of the UE, the components in the first part and the second part. The first part is within a bandwidth 2*B, where B is a positive value. The first part includes components B1, B2, B3 and B4, such that, in a frequency domain, the components B1 and B4 are at lower and higher frequencies, respectively, relative to the components B2 and B3 in the first part and the components B2 and B3 are within a bandwidth B. The seconds part includes at least the components B1 and B4. The components B1 and B4 in the second part are within the bandwidth B in the frequency domain.

### CROSS-REFERENCE TO RELATED AND CLAIM OF PRIORITY

The present application claims priority under 35 U.S.C. § 119 (e) to U.S. Provisional Patent Application No. 63/768,322 filed on Mar. 7, 2025, which is hereby incorporated by reference in its entirety.

### TECHNICAL FIELD

The present disclosure relates generally to wireless communication systems and, more specifically, the present disclosure is related to a unified common channel or signal design for low bandwidth and high bandwidth user equipment (UEs).

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance.

### SUMMARY

The present disclosure relates to a unified common channel or signal design for low bandwidth and high bandwidth UEs.

In one embodiment, a user equipment (UE) is provided. The UE includes a transceiver configured to receive a signal including a first part and a second part. The first part is within a bandwidth 2*B, where B is a positive value. The first part includes components B1, B2, B3 and B4, such that, in a frequency domain, the components B1 and B4 are at lower and higher frequencies, respectively, relative to the components B2 and B3 in the first part and the components B2 and B3 are within a bandwidth B. The seconds part includes at least the components B1 and B4. The components B1 and B4 in the second part are within the bandwidth B in the frequency domain. The UE further includes a processor operably coupled to the transceiver. The processor is configured to select, based on a type of the UE, the components in the first part and the second part.

In another embodiment, a base station (BS) is provided. The BS includes a processor and a transceiver operably coupled to the processor. The transceiver configured to transmit a signal including a first part and a second part, the first part is within a bandwidth 2*B, where B is a positive value. The first part includes components B1, B2, B3 and B4, such that, in a frequency domain, the components B1 and B4 are at lower and higher frequencies, respectively, relative to the components B2 and B3 in the first part and the components B2 and B3 are within a bandwidth B. The seconds part includes at least the components B1 and B4. The components B1 and B4 in the second part are within the bandwidth B in the frequency domain.

In yet another embodiment, a method of operating a UE is provided. The method includes receiving a signal including a first part and a second part and selecting, based on a type of the UE, the components in the first part and the second part. The first part is within a bandwidth 2*B, where B is a positive value. The first part includes components B1, B2, B3 and B4, such that, in a frequency domain, the components B1 and B4 are at lower and higher frequencies, respectively, relative to the components B2 and B3 in the first part and the components B2 and B3 are within a bandwidth B. The seconds part includes at least the components B1 and B4. The components B1 and B4 in the second part are within the bandwidth B in the frequency domain. Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example base station (BS) according to embodiments of the present disclosure;

FIG. 3 illustrates an example UE according to embodiments of the present disclosure;

FIGS. 4A and 4B illustrate an example of a wireless transmit and receive paths according to embodiments of the present disclosure;

FIG. 5 illustrates an example control resource set (CORESET) bandwidth (BW) in relation to an associated bandwidth part (BWP) and carrier bandwidth according to embodiments of the present disclosure;

FIG. 6 illustrates an example resource element group (REG) of a CORESET according to embodiments of the present disclosure;

FIG. 7 illustrates example REG-to-CCE mappings for a CORESET according to embodiments of the present disclosure;

FIG. 8 illustrates an example synchronization signal block (SSB) utilized in a cell search procedure according to embodiments of the present disclosure;

FIG. 9 illustrates an example time-domain and frequency-domain allocation of a CORESET relative to a common resource block (CRB) and an SSB according to embodiments of the present disclosure;

FIGS. 10A-10C illustrate multiplexing patterns for multiplexing CORESET #0 with a corresponding SSB according to embodiments of the present disclosure;

FIGS. 11A-11C illustrate example CORESETs according to embodiments of the present disclosure;

FIG. 12A illustrates an example beam operation in a wireless communication system according to embodiments of the present disclosure;

FIG. 12B illustrates an example multi-beam operation in a wireless communication system according to embodiments of the present disclosure;

FIG. 13 illustrates an example of a transmitter structure for beamforming according to embodiments of the present disclosure;

FIG. 14 illustrates an example transmission of LTE synchronization signals and an LTE physical broadcast channel;

FIGS. 15A and 15B illustrate example SSB structure patterns for various sub-carrier spacings according to embodiments of the present disclosure;

FIG. 16 illustrates an example punctured SSB according to embodiments of the present disclosure;

FIG. 17 illustrates a design choice for an SSB where high-bandwidth UEs and low-bandwidth UEs access the same cell according to embodiments of the present disclosure;

FIG. 18 illustrates yet another design choice for an SSB where high-bandwidth UEs and low-bandwidth UEs access the same cell according to embodiments of the present disclosure;

FIGS. 19A and 19B illustrate alternative example SSBs that can be utilized in a cell search procedure according to embodiments of the present disclosure;

FIGS. 20A and 20B illustrate more alternative example SSBs that can be utilized in a cell search procedure according to embodiments of the present disclosure;

FIGS. 21A-21E illustrate example SSBs with various patterns according to embodiments of the present disclosure;

FIGS. 22A-22D illustrate alternative example SSBs with various patterns according to embodiments of the present disclosure;

FIGS. 23A and 23B illustrate more alternative example SSBs with various patterns according to embodiments of the present disclosure;

FIG. 24 illustrates an example method performed by a UE in a wireless communication system according to embodiments of the present disclosure;

FIG. 25 illustrates an example method performed by a UE in a wireless communication system according to embodiments of the present disclosure;

FIGS. 26A-26E illustrate example SSBs with various patterns according to embodiments of the present disclosure;

FIGS. 27A-27C illustrate alternative example SSBs with various patterns according to embodiments of the present disclosure;

FIGS. 28A-28C illustrate more alternative example SSBs with various patterns according to embodiments of the present disclosure;

FIG. 29 illustrates an example method performed by a UE in a wireless communication system according to embodiments of the present disclosure;

FIG. 30 illustrates an example method performed by a UE in a wireless communication system according to embodiments of the present disclosure;

FIGS. 31A and 31B illustrate example SSBs that can utilize replacement bands according to embodiments of the present disclosure;

FIGS. 32A and 32B illustrate example SSBs that are organized in bursts according to embodiments of the present disclosure; and

FIG. 33 illustrates an example method performed by a UE in a wireless communication system according to embodiments of the present disclosure.

### DETAILED DESCRIPTION

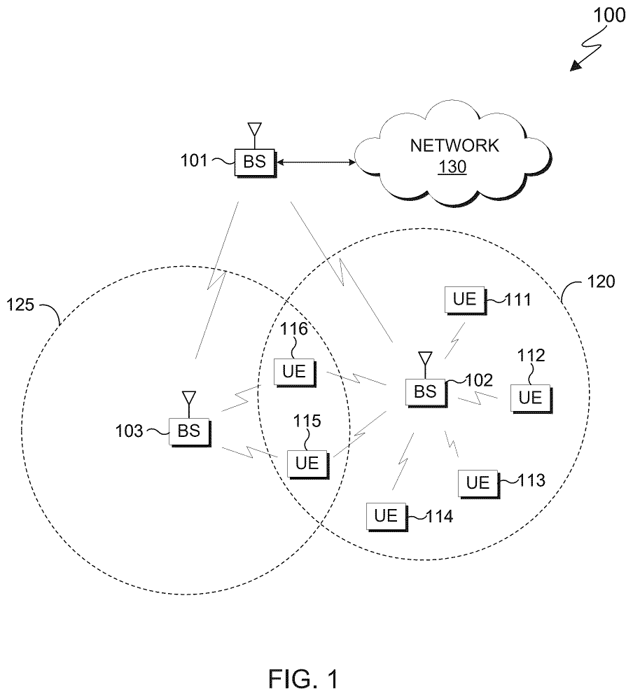

FIGS. 1-33 discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: 3GPP TS 38.211 v18.5.0, “NR; Physical Channels and Modulation” (herein, “REF 1”); 3GPP TS 38.212 v18.5.0, “NR; Multiplexing and Channel Coding” (herein, “REF 2”); 3GPP TS 38.213 v18.5.0, “NR; Physical Layer Procedures for Control” (herein, “REF 3”); 3GPP TS 38.214 v18.5.0, “NR; Physical Layer Procedures for Data” (herein, “REF 4”); 3GPP TS 38.321 v18.4.0, “NR; Medium Access Control (MAC) Protocol Specification” (herein, “REF 5”); and 3GPP TS 38.331 v18.4.0, “NR; Radio Resource Control (RRC) Protocol Specification” (herein, “REF 6”).

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of the present disclosure.

As shown in FIG. 1, the wireless network 100 includes a BS 101 (e.g., base station, BS, eNB, gNB), a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BSs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for utilizing a unified common channel or signal design for low bandwidth and high bandwidth UEs. In certain embodiments, one or more of the BSs 101-103 include circuitry, programing, or a combination thereof to support a unified common channel or signal design for low bandwidth and high bandwidth UEs.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

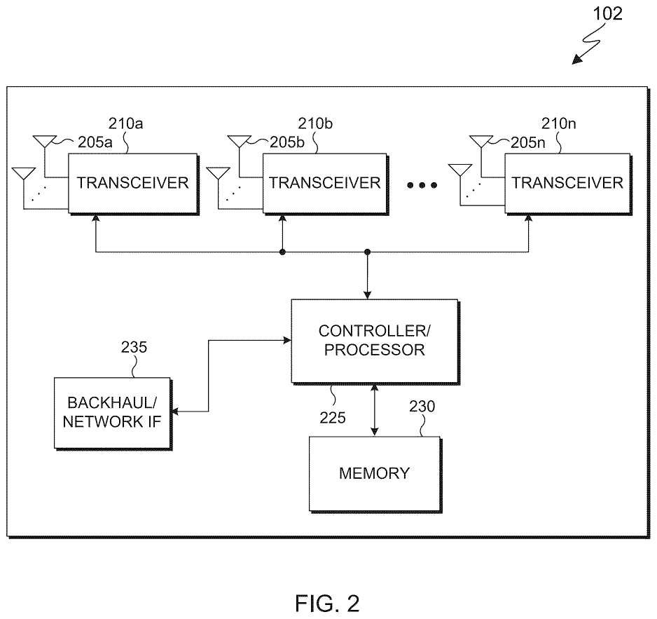

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of the present disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for enabling a unified common channel or signal design for low bandwidth and high bandwidth UEs. Any of a wide variety of other functions could be supported in the BS 102 by the controller/processor 225.

The controller/processor 225 is also capable of executing programs and other processes resident in the memory 230, such as processes to support a unified common channel or signal design for low bandwidth and high bandwidth UEs. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

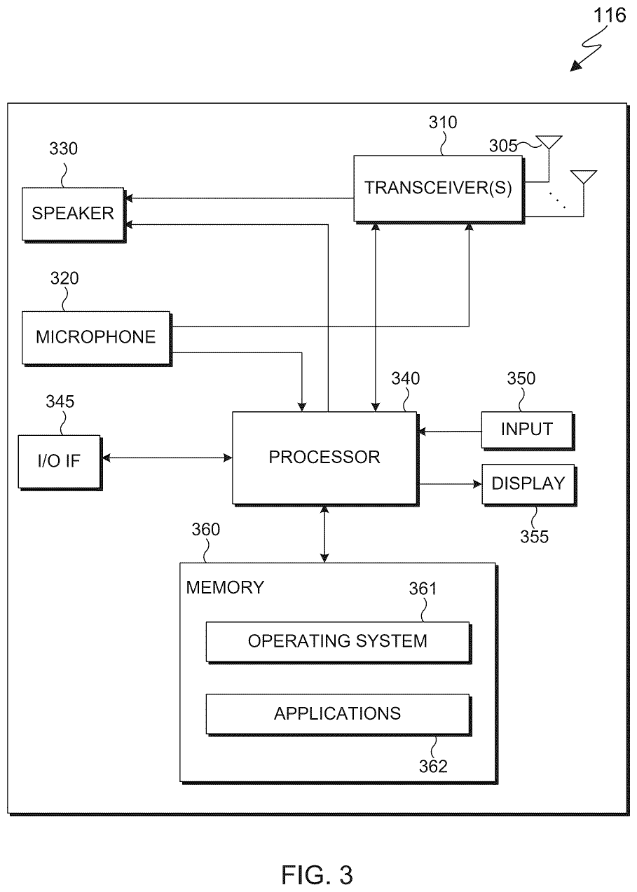

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of the present disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for utilizing a unified common channel or signal design for low bandwidth and high bandwidth UEs as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

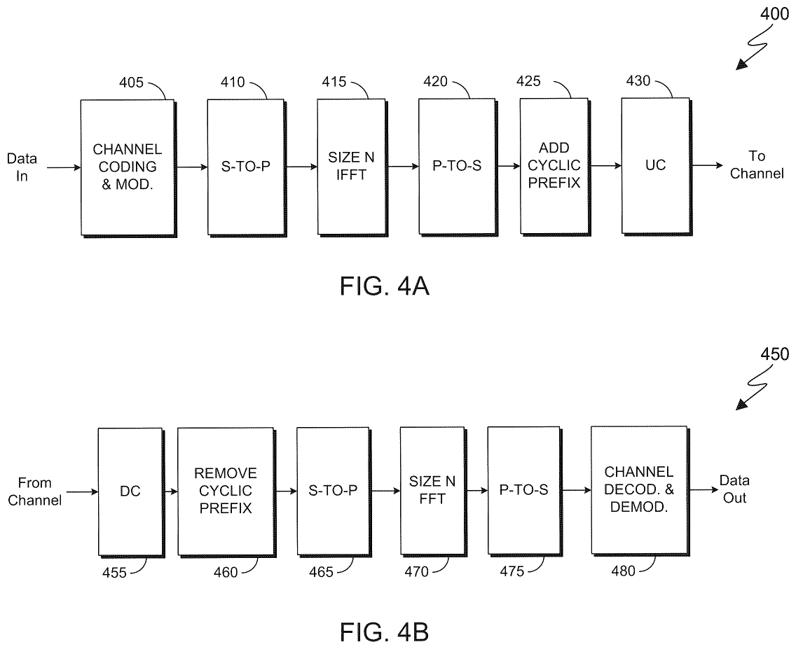

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 and/or the receive path 450 is configured for supporting a unified common channel or signal design for low bandwidth and high bandwidth UEs as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS and the UE. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to the BSs 101-103 and may implement a receive path 450 for receiving in the downlink from the BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In the present disclosure and in general, a time unit for DL signaling, for UL signaling, or for SL signaling on a cell is one symbol. A symbol belongs to a slot that includes a number of symbols such as 14 symbols. A slot can also be used as a time unit. A bandwidth (BW) unit is referred to as a resource block (RB). One RB includes a number of sub-carriers (SCs). For example, a slot can have duration of one millisecond, and an RB can have a bandwidth of 180 kHz and include 12 SCs with inter-SC spacing of 15 kHz. As another example, a slot can have a duration of 0.25 milliseconds and include 14 symbols, and an RB can have a BW of 720 kHz and include 12 SCs with SC spacing of 60 kHz. An RB in one symbol of a slot is referred to as physical RB (PRB) and includes a number of resource elements (REs). A slot can be either full DL slot, full UL slot, or hybrid slot similar to a special subframe in time division duplex (TDD) systems (see also REF 1). In addition, a slot can have symbols for SL communications. A UE can be configured one or more bandwidth parts (BWPs) of a system BW for transmissions or receptions of signals or channels.

DL signals include data signals conveying information content, control signals conveying DL control information (DCI), and reference signals (RS) that are also known as pilot signals. A BS transmits data information or DCI through respective physical DL shared channels (PDSCHs) or physical DL control channels (PDCCHs). A PDSCH or a PDCCH can be transmitted over a variable number of slot symbols including one slot symbol. For brevity, a DCI format scheduling a PDSCH reception by a UE is referred to as a DL DCI format and a DCI format scheduling a physical uplink shared channel (PUSCH) transmission from a UE is referred to as an UL DCI format. A DCI format scheduling PDSCH reception or PUSCH transmission for a single UE, such as a DCI format with CRC scrambled by C-RNTI/CS-RNTI/MCS-C-RNTI as described in 38.212, are referred for brevity as a unicast DCI format. A DCI format scheduling PDSCH reception for multicast communication, such as a DCI format with CRC scrambled by G-RNTI/G-CS-RNTI as described in 38.212, are referred to as multicast DCI format. DCI formats providing various control information to at least a subset of UEs in a serving cell, such as DCI format 2_0 in 38.212, are referred to as group-common (GC) DCI formats.

The downlink physical-layer processing of transport channels on PDSCH can include the following steps: (1) Transport block CRC attachment; (2) Code block segmentation and code block CRC attachment; (3) Channel coding: LDPC coding; (4) Physical-layer hybrid-ARQ processing; (5) Rate matching; (6) Scrambling; (7) Modulation: QPSK, 16QAM, 64QAM, 256QAM, and 1024QAM; (8) Layer mapping; and (9) Mapping to assigned resources and antenna ports.

As aforementioned, the Physical Downlink Control Channel (PDCCH) can be used to schedule DL transmissions on PDSCH and UL transmissions on PUSCH, where the Downlink Control Information (DCI) on PDCCH includes: (1) Downlink assignments containing at least modulation and coding format, resource allocation, and hybrid-ARQ information related to DL-SCH; and (2) Uplink scheduling grants containing at least modulation and coding format, resource allocation, and hybrid-ARQ information related to UL-SCH. In addition to scheduling, PDCCH can be used to for: (1) Activation and deactivation of configured PUSCH transmission with configured grant; (2) Activation and deactivation of PDSCH semi-persistent transmission; (3) Notifying one or more UEs of the slot format; (4) Notifying one or more UEs of the RB(s) and OFDM symbol(s) where the UE may assume no transmission is intended for the UE; (5) Transmission of TPC commands for PUCCH and PUSCH; (6) Transmission of one or more TPC commands for SRS transmissions by one or more UEs; (7) Switching a UE's active bandwidth part; (8) Initiating a random access procedure; (9) Indicating the UE(s) to monitor the PDCCH during the next occurrence of the DRX on-duration; (10) In IAB context, indicating the availability for soft symbols of an IAB-DU; (11) Triggering one shot HARQ-ACK codebook feedback; and (11) For operation with shared spectrum channel access: (11a) Triggering search space set group switching; (11b) Indicating one or more UEs about the available RB sets and channel occupancy time duration; and (11c) Indicating downlink feedback information for configured grant PUSCH (CG-DFI). Polar coding is used for PDCCH. QPSK modulation is used for PDCCH.

The physical resources used for PDCCH are provided by a CORESET configuration. A CORESET configuration provides a time-frequency resource for each associated monitoring occasion, including:
Time and frequency domain resources,
Transmission configuration indication state, for providing a resource reference signal for quasi-co-location (QCL) and a QCL type, and
Scrambling information.

A UE can be configured with one or more CORESETs. A CORESET configuration provides the following parameters:
Control resource set identifier (CORESET ID). A CORESET ID can identify a CORESET configuration.
Frequency domain resources. This is a bitmap of up to 45 bits. Each bit in the bitmap represents a group of 6 consecutive RBs. A “1” in the bitmap indicates that the corresponding group of 6 RBs is included in the CORESET, other a “0” indicates that the corresponding group of 6 RBs is not include in the bitmap.
Duration. The duration is the number of symbols of a CORESET. Duration ∈{1,2,3} symbols.
CCE-REG mapping type. Mapping type can be interleaved or non-interleaved.
   Interleaved mapping type includes; (1) Interleaver size, (2) REG bundle size, and (3) shift index, when shift index is absent, UE applies PCI of serving cell.
precoderGranularity. This can be sameAsREG-bundle or allContiguousRBs.
rb-Offset. Indicates the RB level offset in units of RB from the first RB of the first 6RB group to the first RB of BWP.
pdcch-DMRS-ScramblingID
tci-StatesPDCCH-ToAddList
tci-StatesPDCCH-ToReleaseList
tci-PresentInDCI
controlResourceSetId
followUnifiedTCI-State
applyIndicatedTCI-State

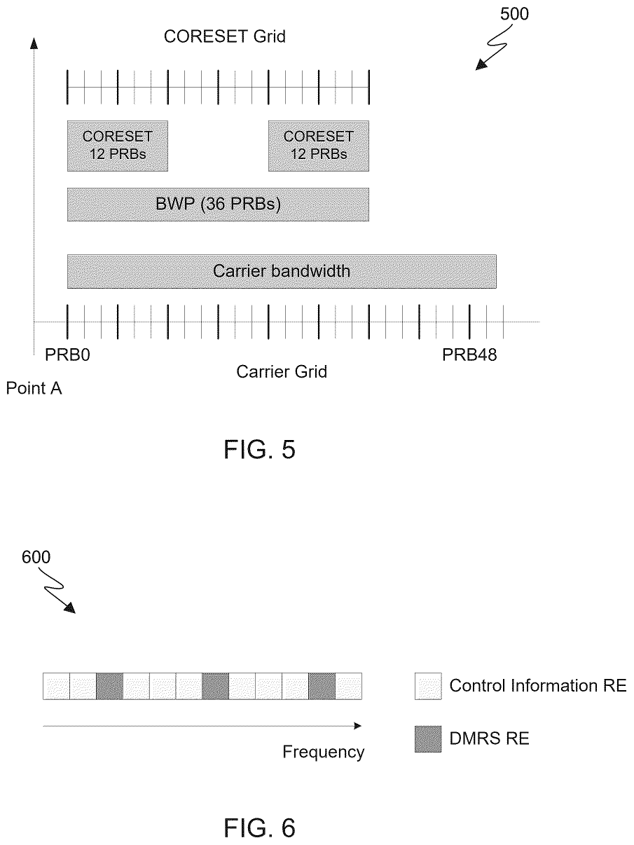

FIG. 5 illustrates an example CORSET BW 500 in relation to an associated bandwidth part (BWP) and carrier bandwidth according to embodiments of the present disclosure. For example, CORESET BW 500 can be implemented by BS 102 of FIG. 1. This example is for illustration only and other embodiments can be used without departing from the scope of the present disclosure.

As illustrated in FIG. 5, the CORESET BW 500 is configured in units of 6 resource blocks (RBs) on a 6 RB frequency grid within the associated BWP. Further, the CORESET BW 500 is configured within the bandwidth of the associated BWP. The groups of 6 RSs belonging to a CORESET is provided by a bitmap by higher layer parameter frequencyDomainResources. The number of RBs in a CORESET is denoted by

$${N}_{R B}^{C O R E S E T} .$$

A CORESET can be configured with a duration of 1, 2 or 3 OFDM symbols, and is denoted by

$${N}_{s y m b}^{C O R E S E T} .$$

A CORESET includes resource element groups (REGs), where a REG is 1 RB, i.e., 12 sub-carriers in one OFDM symbol. The number of REGs in a CORESET, is given by

$${N}_{R E G}^{C O R E S E T} = {N}_{s y m b}^{C O R E S E T} \cdot {N}_{R B}^{C O R E S E T} .$$

FIG. 6 illustrates an example REG 600 of a CORESET according to embodiments of the present disclosure. For example, a CORESET including REG 600 can be implemented by BS 102 of FIG. 1. This example is for illustration only and other embodiments can be used without departing from the scope of the present disclosure.

As illustrated in FIG. 6, three resource elements of the REG are used for a demodulation reference signal (DMRS), and the remaining nine resource elements are used for carrying control information. A resource element is one sub-carrier in one symbol. A control channel element (CCE) includes 6 REGs.

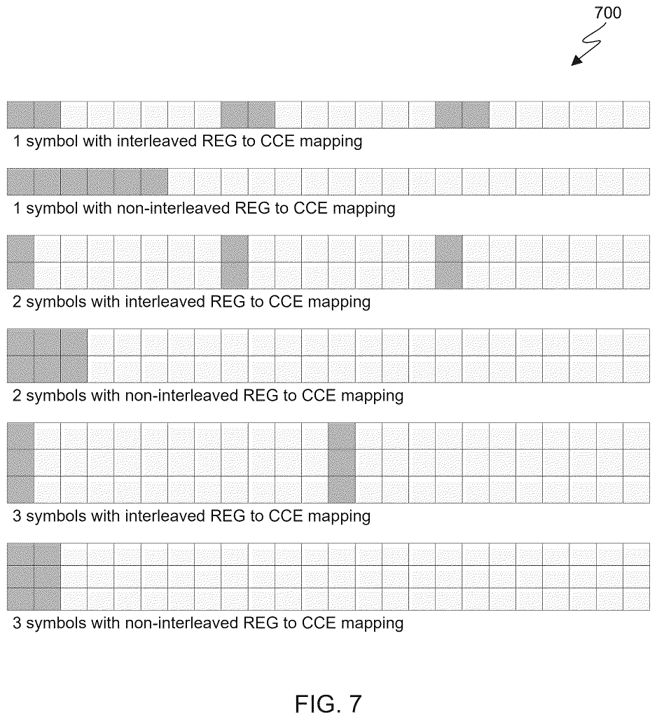

FIG. 7 illustrates example REG-to-CCE mappings 700 for a CORESET according to embodiments of the present disclosure. For example, REG-to-CCE mappings 700 can be utilized for a CORESET implemented by BS 102 of FIG. 1. These examples are for illustration only and other embodiments can be used without departing from the scope of the present disclosure.

A CCE can include one or more REG bundles, where a REG bundle is a set of adjacent REGs in time and/or frequency having a same precoding. As illustrated in FIG. 7 and Table 1 below, a REG bundle size, L, can be 2, 3 or 6 RBs.

$$If {N}_{s y m b}^{C O R E S E T} = 1 , L ∈ \{ 2 , 6 \} . If {N}_{s y m b}^{C O R E S E T} = 2 , 3 , L ∈ \{ {N}_{s y m b}^{C O R E S E T} \} .$$

As further illustrated in FIG. 7 and Table 1, there are two types of CCE-to-REG mapping:
Interleaved CCE-to-REG mapping, where there is one or more REG bundles, and the REGs of a CCE are distributed in frequency.
Non-interleaved CCE-to-REG mapping, where there is a single REG bundle, and the REGs of a CCE are contiguous in frequency.

TABLE 1
REG Bundle Size

| | Non-interleaved mapping | Interleaved mapping |
|---|---|---|
| CORESET duration | bundle size (RBs × | bundle size (RBs × |
| in symbols | Symbols) | Symbols) |
| 1 | 6 (6 × 1) | 2 (2 × 1), 6 (6 × 1) |
| 2 | 6 (6 × 1) | 2 (1 × 2), 6 (6 × 1) |
| 3 | 6 (6 × 1) | 3 (1 × 2), 6 (6 × 1) |

Interleaving achieves better frequency diversity, while a 6-PRB bundle with non-interleaving achieves better channel estimation. Both open-loop and closed-loop precoding are supported. Precoding is applied in a spec transparent manner where the same precoding weights are used across all resource elements of a REG bundle.

Each PDCCH candidate comprises of L of CCEs, where L is the aggregation level (AL). L∈{1,2,4,8,16}. AL 16 is introduced for coverage extension, achieving a gain of 2 to 3 dB over LTE AL 8 at BLER range 10⁻³ to 10⁻¹.

A gNB (such as BS 102) transmits one or more of multiple types of RS including channel state information RS (CSI-RS) and demodulation RS (DMRS). A CSI-RS is primarily intended for UEs to perform measurements and provide channel state information (CSI) to a gNB. For channel measurement, non-zero power CSI-RS (NZP CSI-RS) resources are used. For interference measurement reports (IMRs), CSI interference measurement (CSI-IM) resources associated with a zero power CSI-RS (ZP CSI-RS) configuration are used. A CSI process includes NZP CSI-RS and CSI-IM resources. A UE (such as UE 116) can determine CSI-RS transmission parameters through DL control signaling or higher layer signaling, such as radio resource control (RRC) signaling from a gNB. Transmission instances of a CSI-RS can be indicated by DL control signaling or configured by higher layer signaling. A DMRS is transmitted only in the BW of a respective PDCCH or PDSCH and a UE can use the DMRS to demodulate data or control information.

UL signals also include data signals conveying information content, control signals conveying UL control information (UCI), DMRS associated with data or UCI, sounding RS (SRS) enabling a gNB to perform UL channel measurement, and a random access (RA) preamble enabling a UE to perform random access. A UE transmits data information or UCI through a respective physical UL shared channel (PUSCH) or a physical UL control channel (PUCCH). A PUSCH or a PUCCH can be transmitted over a variable number of slot symbols including one slot symbol. The gNB can configure the UE to transmit signals on a cell within an UL BWP of the cell UL BW.

UCI includes hybrid automatic repeat request acknowledgement (HARQ-ACK) information, indicating correct or incorrect detection of data transport blocks (TBs) in a PDSCH, scheduling request (SR) indicating whether a UE has data in the buffer of UE, link recovery request (LRR) for beam failure recovery, UE initiated report indication (UEI) for a UE initiated beam report, and CSI reports enabling a gNB to select appropriate parameters for PDSCH or PDCCH transmissions to a UE. HARQ-ACK information can be configured to be with a smaller granularity than per TB and can be per data code block (CB) or per group of data CBs where a data TB includes a number of CBs or CBGs.

A CSI report from a UE can include a channel quality indicator (CQI) informing a gNB of a largest modulation and coding scheme (MCS) for the UE to detect a data TB with a predetermined block error rate (BLER), such as a 10% BLER, of a precoding matrix indicator (PMI) informing a gNB how to combine signals from multiple transmitter antennas in accordance with a multiple input multiple output (MIMO) transmission principle, and of a rank indicator (RI) indicating a transmission rank for a PDSCH. UL RS includes DMRS and SRS. DMRS is transmitted only in a BW of a respective PUSCH or PUCCH transmission. A gNB can use a DMRS to demodulate information in a respective PUSCH or PUCCH. SRS is transmitted by a UE to provide a gNB with an UL CSI and, for a TDD system, an SRS transmission can also provide a PMI for DL transmission. Additionally, in order to establish synchronization or an initial higher layer connection with a gNB, a UE can transmit a physical random-access channel (PRACH).

An antenna port is defined such that the channel over which a symbol on the antenna port is conveyed can be inferred from the channel over which another symbol on the same antenna port is conveyed.

Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters.

The UE (such as the UE 116) may assume that synchronization signal (SS)/PBCH block (also denoted herein as SSBs) transmitted with the same block index on the same center frequency location are quasi co-located with respect to Doppler spread, Doppler shift, average gain, average delay, delay spread, and, when applicable, spatial Rx parameters. The UE may not assume quasi co-location for any other synchronization signal SS/PBCH block transmissions.

In absence of CSI-RS configuration, and unless otherwise configured, the UE may assume PDSCH DM-RS and SSB to be quasi co-located with respect to Doppler shift, Doppler spread, average delay, delay spread, and, when applicable, spatial Rx parameters. The UE may assume that the PDSCH DM-RS within the same code division multiplexing (CDM) group is quasi co-located with respect to Doppler shift, Doppler spread, average delay, delay spread, and spatial Rx. The UE may also assume that DM-RS ports associated with a PDSCH are QCL with QCL type A, type D (when applicable) and average gain. The UE may further assume that no DM-RS collides with the SS/PBCH block.

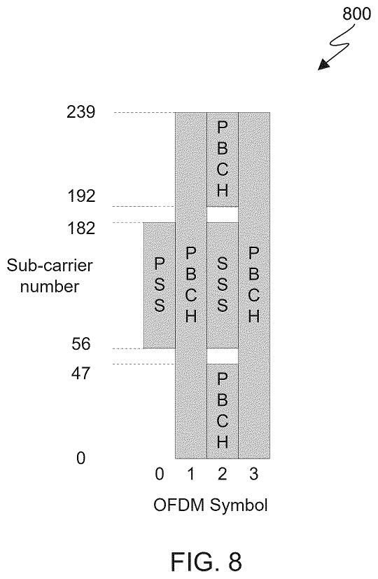

FIG. 8 illustrates an example SSB 800 utilized in a cell search procedure according to embodiments of the present disclosure. For example, SSB 800 can be transmitted by BS 102 or received by any one of the UEs 111-116 of FIG. 1. This example is for illustration only and other embodiments can be used without departing from the scope of the present disclosure.

In 5G/NR, a UE performs the cell search procedure to acquire time and frequency synchronization with a cell and to detect the physical layer Cell ID of the cell. As illustrated in FIG. 8, to perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 physical resource blocks (240 subcarriers).

SSBs are organized in groups or bursts of up to N SSBs, transmitted within half a frame, each SSB within the group has an index i, where i=0, 1, . . . , N−1, within each group or burst of SSBs, the SSBs are time-division multiplexed and arranged in increasing order of i, with increasing time. For carrier frequencies less than or equal to 3 GHZ, N=4. For carrier frequencies in FR1 that are larger than 3 GHZ, N=8. For carrier frequencies in FR2, N=64. The actual SSB indices transmitted are provided by ssb-PositionsInBurst in system information block one (SIB1) or in ServingCellConfigCommon or in SSB-MTC-AdditionalPCI or in LTM-SSB-Config.

SSBs are transmitted periodically, where the allowed periodicities are {5, 10, 20, 40, 80, 160} ms. In addition to cell search, SSBs can also be used for beam management related procedures, such as new beam acquisition, beam measurements, and beam failure detection and recovery. Each SSB with index i can be associated with a spatial domain filter (or beam).

After detecting the PSS and SSS, the UE proceeds with receiving the PBCH. The PBCH provides the UE with essential information for accessing the system such as: (1) time domain information provided by SSB index and system frame number; (2) frequency domain information (offset of SSB in frequency domain relative to CRB); (3) information about how to receive other essential system information (configuration of CORESET zero and search space zero). This information can be provided by higher layers as part of the master information block (MIB) or can be information that the physical layer adds to the PBCH block as described later, or can be information implicitly included in the PBCH, e.g., carried by the PBCH DM-RS, as described later. For example, part of the SSB index (3 MSBs when Lₘₐₓ=64) is included in the PBCH block. Another part of the SSB index (e.g., 3 LSBs when Lₘₐₓ≥4 or 2 LSBs when Lₘₐₓ=4) are implicitly signaled based on scrambling code of encoded PBCH block or based on PBCH DM-RS sequence.

The master information block (MIB) is transmitted in the PBCH. The MIB contains critical information to allow the UE to access the system and receive the remaining minimum system information (RMSI) transmitted in SIB1. The MIB has a periodicity of 80 ms and can be repeated within the 80 ms period based on the periodicity of the SSB. The same MIB is transmitted across all SSBs within a same SSB burst set. The MIB block is defined as (TS 38.331):

```
MIB ::=  SEQUENCE {
  systemFrameNumber  BIT STRING (SIZE (6)),
  subCarrierSpacingCommon  ENUMERATED {scs15or60, scs30or120},
  ssb-SubcarrierOffset  INTEGER (0..15),
  dmrs-TypeA-Position  ENUMERATED {pos2, pos3},
  pdcch-ConfigSIB1  PDCCH-ConfigSIB1,
  cellBarred  ENUMERATED {barred, notBarred},
  intraFreqReselection  ENUMERATED {allowed, notAllowed},
  spare  BIT STRING (SIZE (1))
}
Where:
PDCCH-ConfigSIB1 ::=  SEQUENCE {
  controlResourceSetZero  ControlResourceSetZero,
  search SpaceZero  Search SpaceZero
}
```

For pdcch-ConfigSIB1: controlResourceSetZero is a 4-bit field. This field configures CORESET #0 for the UE to monitor a PDCCH scheduling SIB1. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1.

For pdcch-ConfigSIB1: searchSpaceZero is a 4-bit field. This field configures SearchSpace #0 for initial BWP for the UE to monitor a PDCCH scheduling SIB1. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1.

As aforementioned, SIB1 provides the UE the remaining minimum system information for the UE to access the system. SIB1 is carried by PDSCH scheduled by a PDCCH with a CRC scrambled by an SI-RNTI. The PDCCH is scheduled in Type1-PDCCH common search space (CSS) provided by Search Space #0 associated with CORESET #0.

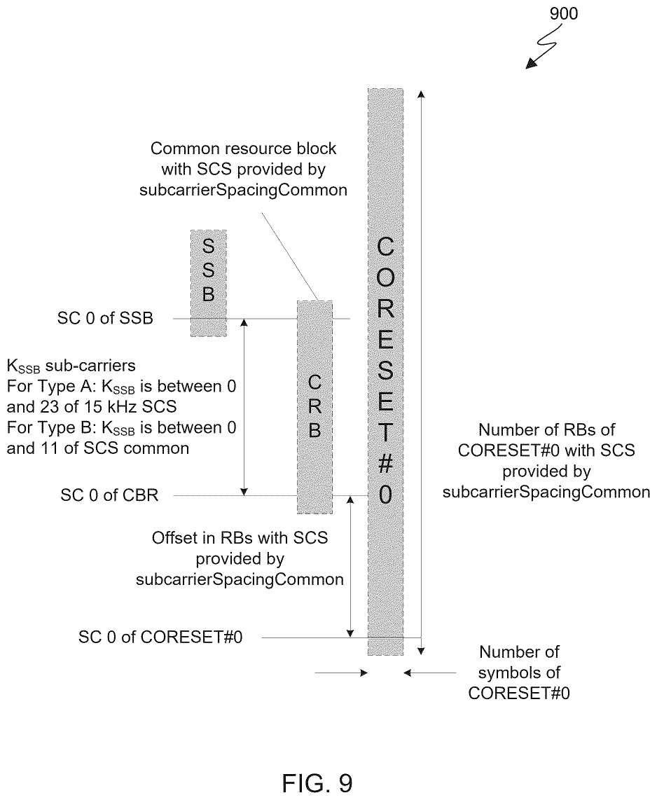

FIG. 9 illustrates an example time-domain and frequency-domain allocation 900 of a CORESET relative to a CRB and an SSB according to embodiments of the present disclosure. For example, allocation 900 can be determined by any of the UEs 111-116 of FIG. 1 based on certain parameters in the MIB provided by BS 102 of FIG. 1. This example is for illustration only and other embodiments can be used without departing from the scope of the present disclosure.

During a cell search, the UE can determine time-domain and frequency-domain allocation of a CORESET for Type0-PDCCH CSS set based on pdcch-ConfigSIB1->controlResourceSetZero in the MIB.
Based on the sub-carrier spacing of SSB (as determined by the UE), the sub-carrier spacing of SIB1 (as determined by subCarrierSpacingCommon in the MIB), and the minimum channel bandwidth, a table is selected from Table 13-0 to Table 13-10 of TS 38.213 for operation without shared spectrum channel access in FR1 and FR2-1, or as described in in Tables 13-1A and 13-4A of TS 38.213 for operation with shared spectrum channel access in FR1, or as described in Table 13-10A of TS 38.213 for FR2-2.
controlResourceSetZero is 4-bits (ranging from 0 to 15) and determines a row in the selected table.
Based on the determined row, the UE determines (1) the number of RBs of CORESET #0

$$( {N}_{R B}^{C O R E S E T} ) , wherein {N}_{R B}^{C O R E S E T} ∈ \{ 12 , 24 , 48 , 96 \} ;$$

(2) the number of symbols of

$$CORESET \#0 ( {N}_{s y m b}^{C O R E S E T} ) wherein {N}_{s y m b}^{C O R E S E T} ∈ \{ 1 , 2 , 3 \} ,$$

the offset in RBs with respect to subCarrierSpacingCommon provided by the MIB, and the SS/PBCH block and CORESET multiplexing pattern.
The offset, in RBs with respect to subCarrierSpacingCommon, determines the starting RB of CORESET #0 relative to a common resource block with subCarrierSpacingCommon that overlaps sub-carrier 0 of the SS/PBCH block as illustrated in FIG. 9.

Table 13-0 has been introduced in Rel-18 for narrow-band UEs (with 3 MHz bandwidth). Table 13-0 allows for CORESETs with 12 RBs to fit within an allocation of a narrow-band UEs. At 15 kHz, a 12 RB CORESET has a bandwidth of 2.16 MHz, which is within the bandwidth of 3 MHz UE. However, a fewer number of RBs leads to fewer CCEs and fewer number of PDCCH candidates.

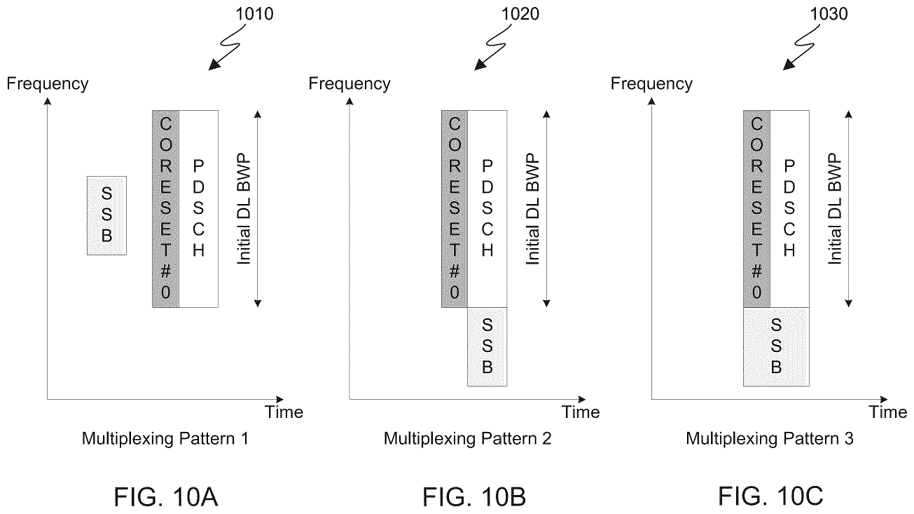

FIGS. 10A-10C illustrate multiplexing patterns 1010-1030 for multiplexing CORESET #0 with a corresponding SSB according to embodiments of the present disclosure. For example, multiplexing patterns 1010-1030 can be implemented by BS 102 of FIG. 1. This example is for illustration only and other embodiments can be used without departing from the scope of the present disclosure.

As illustrated in FIGS. 10A-10C, NR supports 3 multiplexing patterns for multiplexing CORESET #0 with the corresponding SSB.
Multiplexing pattern 1 can be used for FR1 or FR2. The SSB is time division multiplexed with the PDCCH scheduling SIB1, and SSB overlaps CORESET #0 in the frequency domain as illustrated in FIG. 10A.
Multiplexing pattern 2 and multiplexing pattern 3 are used for FR2, where beam-based operation facilitates communication between the gNB and the UE. Therefore, reducing beam sweeping overhead in the time domain is an important consideration. The larger system bandwidth in FR2 can be leveraged to frequency-division multiplex the SSB and the corresponding CORESET #0 as illustrated in FIG. 10B for multiplexing pattern 2 and in FIG. 10C for multiplexing pattern 3.

As aforementioned, CORESET #0 is configured by ControlResourceSetZero, and the following parameters determine the configuration of CORESET #0:

$${N}_{R B}^{C O R E S E T} and {N}_{s y m b}^{C O R E S E T}$$

are defined based on Tables 13-0 to 13-10 of TS 38.213.
Interleaved mapping

$$L = 6$$

$$R = 2$$

$${n}_{s h i f t} = {N}_{I D}^{cell}$$

Normal cyclic prefix
Same precoding within REG bundle.

As aforementioned, Table 13-0 of TS 38.213 was introduced in Rel-18 for small bandwidth UEs, and the allowed CORESET sizes are:
12 PRBs for 3 MHz (future railway mobile communication system (FRMCS))
   Has a special sync raster frequency
   CORESET size is 12 PRBs×2 or 3 symbols—24 or 36 REGs—4 or 6 CCEs.
   Maximum aggregation level is 4
   Interleaved pattern with R=2
15 PRBs for 3 MHz
   Multiple sync raster frequencies different from other NR sync raster points
   CORESET is 24 PRBs (with 9 PRBs punctured)×2 or 3 symbols—48 or 72 REGs—8 or 12 CCEs (3 CCEs or 5 CCEs punctured)
   With or without interleaving. For interleaving R=2.
20 PRBs for 5 MHz (FRMCS)
   Has a special sync raster frequency
   CORESET is 24 PRBs (with 4 PRBs punctured)×2 or 3 symbols—48 or 72 REGs—8 or 12 CCEs (2 CCEs punctured)
   Interleaved pattern with R=2.

The present disclosure considers a CORESET configuration that can be used by normal UEs and low-bandwidth UEs, the structure of the CORESET, e.g., number of symbols and number of RBs depends on the type of UE. Signaling in the MIB and/or dynamic signaling can indicate the types of UE accessing the CORESET, and hence free-up resources not used.

In NR CORESET #0 can have a resource size in the frequency domain of 24 or 48 or 96 RBs. This corresponds to a bandwidth, which depends on the sub-carrier spacing of the CORESET, of 4.32, 8.64 or 17.28 MHz respectively at 15 kHz, and 8.64, 17.28 or 34.56 MHz respectively at 30 kHz, and 17.28, 34.56 or 69.12 MHz respectively at 60 kHz, and 34.28, 69.12 or 138.24 MHz respective at 120 kHz. Such bandwidth values can be too high for low-bandwidth UEs. In NR, this issue was address by one of the following: (1) Introducing a CORESET with 12 RBs, (2) puncturing RBs of the CORESET (or resource element groups (REGs)) that are outside the supported BWs of the UE.

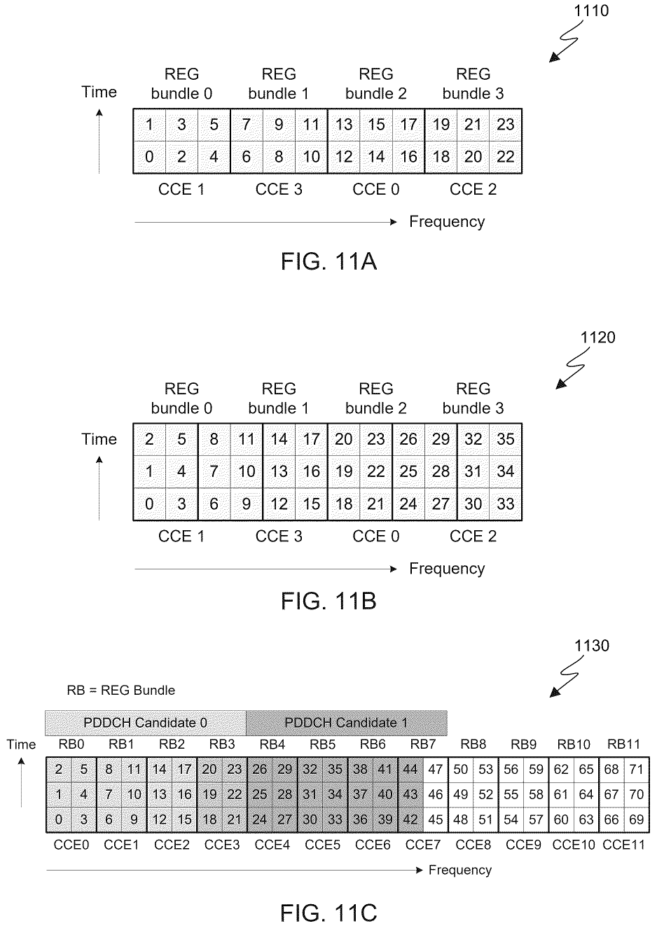

FIGS. 11A-11C illustrate example CORESETs 1110-1130 according to embodiments of the present disclosure. For example, CORESETs 1110-1130 can be implemented by BS 102 of FIG. 1. This example is for illustration only and other embodiments can be used without departing from the scope of the present disclosure.

Supporting a smaller number of RBs, with the same number of symbols for the CORESET, reduces the number of CCEs, and hence number of available PDCCHs candidates and/or the aggregation level. For example, FIG. 11A illustrates CORESET 1110 with 12 RBs and 2 symbols and CORESET 1120 with 12 RBs and 3 symbols. The number of CCEs is 4 and 6 respectively. With aggregation level (AL)=4, there is 1 PDCCH candidate, AL=8 is not possible as there is less than 8 CCEs available, and with AL=2, there is 2 or 3 PDCCH candidates respectively.

On the other hand, if REGs that are outside the bandwidth of the UE in a CORESET are punctured, this reduces the number of available PDCCH candidates and can lead to some PDCCH candidates with fewer REGs or CCEs. For example, FIG. 11C illustrates CORESET 1130 with 3 symbols and 24 RBs. The bandwidth of CORESET 1130 is limited to 15 RBs, therefore, the upper 9 RBs are punctured. CORESET 1130 of FIG. 11C is without interleaving. There are two PDCCH candidates with AL=4, the first PDCCH candidate has 4 CCEs, with each CCE having 6 REGs. The second PDCCH candidate has 4 CCEs, with 3 CCEs having 6 REGs, and one CCE have 3 REGs. Hence, the second PDCCH candidate has fewer resources and is expected to have less performance.

To address this issue, the present disclosure considers a CORESET with multiple configurations, for example, a first configuration with more RBs and less symbols used for standard or normal UEs with large BW, and a second configuration with less RBs and more symbols used for low-bandwidth UEs, the indexing of the REGs, CCEs and PDCCH candidate can be such that both types of UEs can co-exist in the CORESET. Alternatively, 2 CORESETs are configured that overlap, with a first CORESET with more RBs and less symbols used for standard or normal UEs with large BW, and second CORESET with less RBs and more symbols used for low-bandwidth UEs, the indexing of the REGs, CCEs and PDCCH candidate can be such that both types of UEs can co-exist in the CORESETs. While, the disclosure refers to the first description, the second description may be implemented/applied in a similar/corresponding manner. When one type of UEs is not used in a slot or monitoring occasion, the CORESET resources corresponding to that type of UE can be indicated as not being used or as being available and hence can be used for other channels such as DL transmissions or UL transmissions. Further, the present disclosure considers design and signalling aspects for a CORESET with multiple configurations.

Further in the present disclosure and in general, a beam can be determined by any of:
A TCI state, that establishes a quasi-colocation (QCL) relationship or spatial relation between a source reference signal (e.g. SSB and/or CSI-RS) and a target reference signal.
A spatial relation information that establishes an association to a source reference signal, such as SSB or CSI-RS or SRS.
   In either case, the ID of the source reference signal identifies the beam.

The TCI state and/or the spatial relation reference RS can determine a spatial Rx filter for reception of downlink channels at the UE, or a spatial Tx filter for transmission of uplink channels from the UE. The TCI state and/or the spatial relation reference RS can determine a spatial Tx filter for transmission of downlink channels from the gNB, or a spatial Rx filter for reception of uplink channels at the gNB.

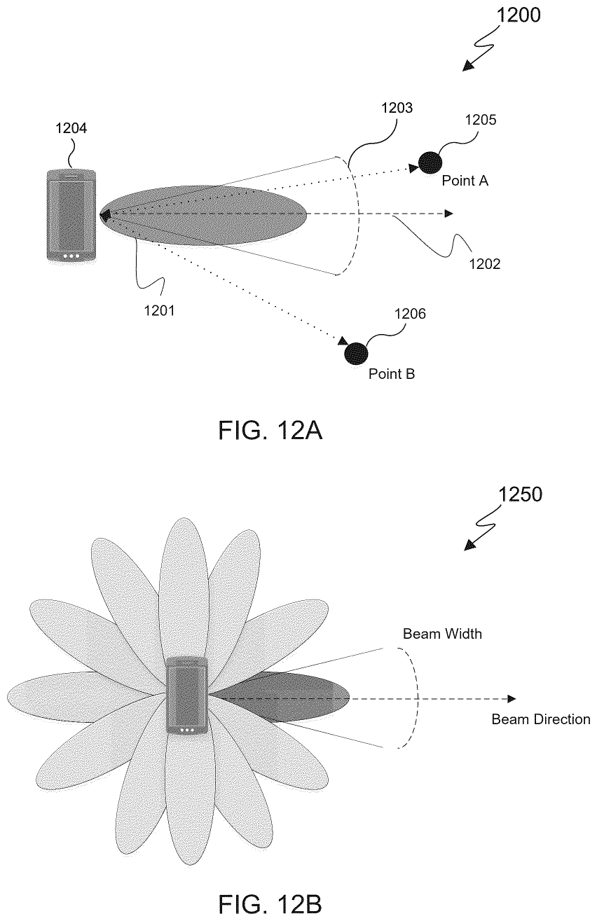

FIG. 12A illustrates an example beam operation 1200 in a wireless communication system according to embodiments of the present disclosure. For example, beam operation 1200 can be implemented by BS 102 and/or any of the UEs 111-116 of FIG. 1. This example is for illustration only and other embodiments can be used without departing from the scope of the present disclosure.

As illustrated in FIG. 12A, in a wireless system, a beam (1201), for a device (1204), can be characterized by a beam direction (1202) and a beam width (1203). For example, a device (1204) transmits radio frequency (RF) energy in a beam direction and within a beam width. A device (1204) receives RF energy in a beam direction and within a beam width. As illustrated in FIG. 12A, a device at point A (1205) can receive from and transmit to device (1204) as Point A is within a beam width and direction of a beam from device (1204). As illustrated in FIG. 12A, a device at point B (1206) cannot receive from and transmit to device (1204) as Point B is outside a beam width and direction of a beam from device (1204). While FIG. 12A, for illustrative purposes, shows a beam in 2-dimensions (2D), it should be apparent to those skilled in the art, that a beam can be in 3-dimensions (3D), where the beam direction and beam width are defined in space.

FIG. 12B illustrates an example multi-beam operation 1250 in a wireless communication system according to embodiments of the present disclosure. For example, multi-beam operation 1250 can be implemented by BS 102 and/or any of the UEs 111-116 of FIG. 1. This example is for illustration only and other embodiments can be used without departing from the scope of the present disclosure.

As illustrated in FIG. 12B, in a wireless system, a device can transmit and/or receive on multiple beams. This is known as “multi-beam operation.” While FIG. 12B, for illustrative purposes, shows beams in 2D, it should be apparent to those skilled in the art, that beams can be 3D, where the beams can be transmitted to or received from any direction in space.

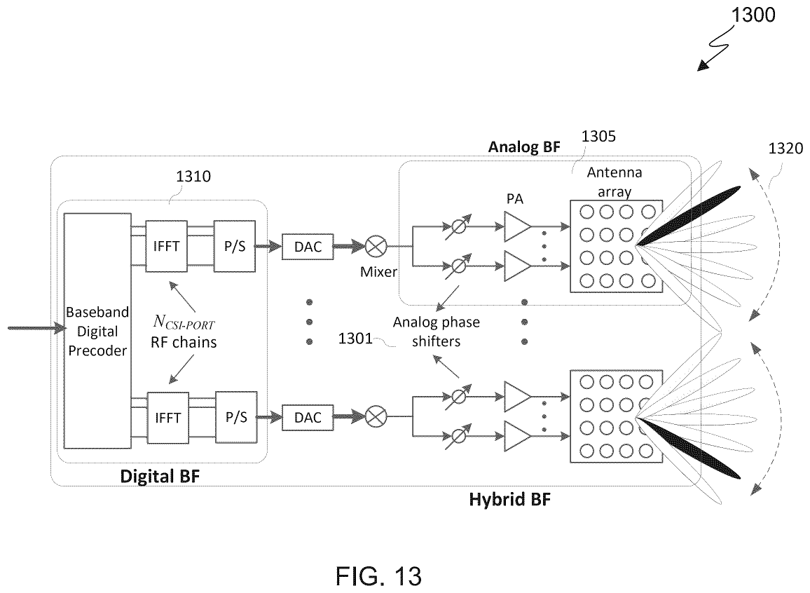

FIG. 13 illustrates an example of a transmitter structure 1300 for beamforming according to embodiments of the present disclosure. In certain embodiments, one or more of BS 102 or UE 116 includes the transmitter structure 1300. For example, one or more of antenna 205 and its associated systems or antenna 305 and its associated systems can be included in transmitter structure 1300. This example is for illustration only and other embodiments can be used without departing from the scope of the present disclosure.

Accordingly, embodiments of the present disclosure recognize that Rel-14 LTE and Rel-15 NR support up to 32 CSI reference signal (CSI-RS) antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 13. Then, one CSI-RS port can be mapped onto a large number of antenna elements that can be controlled by a bank of analog phase shifters 1301. One CSI-RS port can then correspond to one sub-array which produces a narrow analog beam through analog beamforming 1305. This analog beam can be configured to sweep across a wider range of angles 1320 by varying the phase shifter bank across symbols or slots/subframes. The number of sub-arrays (equal to the number of RF chains) is the same as the number of CSI-RS ports NCSI-PORT. A digital beamforming unit 1310 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 1300 of FIG. 13 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 13 is also applicable to higher frequency bands such as >52.6 GHz (also termed frequency range 4 or FR4). In this case, the system can employ only analog beams. Due to the O2 absorption loss around 60 GHz frequency (~10 dB additional loss per 100 m distance), a larger number and narrower analog beams (hence a larger number of radiators in the array) are essential to compensate for the additional path loss.

Rel-17 introduced the unified TCI framework, where a unified or master or main or indicated TCI state is signaled to the UE. The unified or master or main or indicated TCI state can be one of:
1. In case of joint TCI state indication, wherein a same beam is used for DL and UL channels, a joint TCI state that can be used at least for UE-dedicated DL channels and UE-dedicated UL channels.
2. In case of separate TCI state indication, wherein different beams are used for DL and UL channels, a DL TCI state that can be used at least for UE-dedicated DL channels.
3. In case of separate TCI state indication, wherein different beams are used for DL and UL channels, a UL TCI state that can be used at least for UE-dedicated UL channels.

The unified (master or main or indicated) TCI state is TCI state of UE-dedicated reception on PDSCH/PDCCH or dynamic-grant/configured-grant based PUSCH and all of dedicated PUCCH resources.

The unified TCI framework applies to intra-cell beam management, wherein, the TCI states have a source RS that is directly or indirectly associated, through a quasi-co-location relation, e.g., spatial relation, with an SSB of a serving cell (e.g., the TCI state is associated with a TRP of a serving cell). The unified TCI state framework also applies to inter-cell beam management, wherein a TCI state can have a source RS that is directly or indirectly associated, through a quasi-co-location relation, e.g., spatial relation, with an SSB of cell that has a physical cell identity (PCI) different from the PCI of the serving cell (e.g., the TCI state is associated with a TRP of a cell having a PCI different from the PCI of the serving cell).

Quasi-co-location (QCL) relation, can be quasi-location with respect to one or more of the following relations [TS 38.214-section 5.1.5]:
Type A, {Doppler shift, Doppler spread, average delay, delay spread}
Type B, {Doppler shift, Doppler spread}
Type C, {Doppler shift, average delay}
Type D, {Spatial Rx parameter}.

In addition, quasi-co-location relation and source reference signal can also provide a spatial relation for UL channels, e.g., a DL source reference signal provides information on the spatial domain filter to be used for UL transmissions, or the UL source reference signal provides the spatial domain filter to be used for UL transmissions, e.g., same spatial domain filter for UL source reference signal and UL transmissions.

The unified (master or main or indicated) TCI state applies at least to UE dedicated DL and UL channels. The unified (master or main or indicated) TCI can also apply to other DL and/or UL channels and/or signals e.g. non-UE dedicated channel and sounding reference signal (SRS).

A UE is indicated a TCI state by MAC CE when the CE activates one TCI state code point. The UE applies the TCI state code point after a beam application time from the corresponding HARQ-ACK feedback. A UE is indicated a TCI state by a DL related DCI format (e.g., DCI Format 1_1, or DCI format 1_2), wherein the DCI format includes a “transmission configuration indication” field that includes a TCI state code point out of the TCI state code points activated by a MAC CE. A DL related DCI format can be used to indicate a TCI state when the UE is activated with more than one TCI state code points. The DL related DCI format can be with a DL assignment for PDSCH reception or without a DL assignment. A TCI state (TCI state code point) indicated in a DL related DCI format is applied after a beam application time from the corresponding HARQ-ACK feedback.

As set forth above, in 5G/NR, a UE performs the cell search procedure to acquire time and frequency synchronization with a cell and to detect the physical layer Cell ID of the cell. Once again, as illustrated in FIG. 8, to perform cell search, the UE receives the following signals and channel: (1) the primary synchronization signal (PSS), (2) the secondary synchronization signal (SSS) and (3) the physical broadcast channel (PBCH). A PSS/SSS/PBCH block (SS/PBCH block) is referred to as SSB and includes 4 consecutive symbols, and 20 physical resource blocks (240 subcarriers).

More particularly, FIG. 8 illustrates the structure of SSB 800. The first symbol includes the primary synchronization signal (PSS) mapped to the 12 middle RBs of the SSB. The 4 outer RBs of the first symbol of the SSB at each edge are empty. The third symbol includes the secondary synchronization signal (SSS) mapped to the 12 middle RBs of the SSB. The second and fourth symbols as well as the 4 outer RBs of the SSBs of the third are mapped to PBCH. For a 3 MHz channel bandwidth, the PBCH is further punctured equally from both edges to span 144 sub-carriers (i.e., 12 RBs).

The RBs allocated to PBCH include PBCH DM-RS, which is mapped to 3 out of 12 resource elements (REs) of each RB. The starting position of the REs used for PBCH DM-RS is determined based on the cell ID. PBCH uses Polar coding and QPSK modulation. The same sub-carrier spacing is applied to PSS, SSS and PBCH. The SSB is transmitted periodically with a period that can be one of {5, 10, 20, 40, 80, 160} ms, with 20 ms being the default period used by the UE before accessing the network. Within each period there are Lₘₐₓ SSBs, where Lₘₐₓ depends on the carrier frequency.

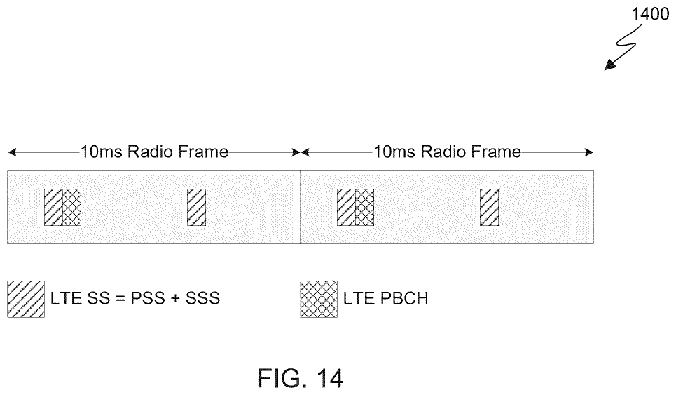

FIG. 14 illustrates an example transmission 1400 of LTE synchronization signals and an LTE physical broadcast channel for comparison purposes. For example, transmission 1400 could have been implemented by BS 102 of FIG. 1. This example is for illustration only and other embodiments can be used without departing from the scope of the present disclosure.

As illustrated in FIG. 14, in LTE, the synchronization signals (LTE SS=LTE PSS and LTE SSS) are transmitted with a 5 ms periodicity, while the LTE physical broadcast channel (PBCH) is transmitted with a 10 ms periodicity. The LTE SS and LTE PBCH have 6 RBs, comprising of 72 sub-carriers with a sub-carrier spacing of 15 kHz, i.e., the LTE SS and LTE PBCH have a bandwidth of 1.08 MHz.

In NR, the PSS is generated using a BPSK modulated m-sequence of length 127, with a cyclic shift that depends on the

$${N}_{ID}^{( 2 )}$$

component of the physical cell identity (PCI). While in LTE, Zadoff-Chu sequence is used for the generation of the LTE PSS. The m-sequence NR for PSS is given by:

x(i+7)=(x(i+4)+x(i))mod 2;

where, the initial state of the shift registered of the m-sequence is given by:

[x(6) x(5) x(4) x(3) x(2) x(1) x(0)]=[1 1 1 0 1 1 0].

Three different BPSK modulated signals, for PSS, are generated from the m-sequence, using

$${N}_{ID}^{( 2 )} ∈ \{ 0 , 1 , 2 \} ,$$

given by:

$${d}_{P S S} ( n ) = 1 - 2 x ( ( n + 43 {N}_{ID}^{( 2 )} ) mod 127 ) ;$$

where, n=0, 1, . . . , 126. The PSS is mapped to the first OFDM symbol of the SSB, as illustrated in FIG. 8. The PSS is mapped to sub-carriers 56 to 182 of the SSB in increasing order of n.

In NR, the SSS is generated using a Gold sequence that is the product of two BPSK modulated m-sequences, of length 127, with cyclic shifts determined by the

$${N}_{ID}^{( 1 )}$$

component and the

$${N}_{ID}^{( 2 )}$$

of the PCI. The first m-sequence used to generate the Gold sequence of the SSS is given by:

x₀(i+7)=(x₀(i+4)+x₀(i)) mod 2;

where, the initial state of the shift register of the first m-sequence is given by:

[x(6) x(5) x(4) x(3) x(2) x(1) x(0)]=[0 0 0 0 0 0 1].

The second m-sequence used to generate the Gold sequence of the SS is given by:

x1(i+7)=(x1(i+1)+x1(i))mod 2;

where, the initial state of the shift register of the second m-sequence is given by:

[x₁(6) x₁(5) x₁(4) x₁(3) x₁(2) x₁(1) x₁(0)]=[0 0 0 0 0 0 1].

The SSS is generated using cyclic shift sequences from the first m-sequence and the second m-sequence:

d_{SSS}(n)=[1−2x₀((n+m₀)mod 127)][1−2x₁((n+m₁)mod 127)];

where,

$${m}_{0} = 15 ⌊ {N}_{ID}^{( 1 )} / 112 ⌋ + 5 {N}_{ID}^{( 2 )} , {m}_{1} = {N}_{ID}^{( 1 )} mod 112 ,$$

and n=0, 1, . . . , 126.

$${N}_{ID}^{( 1 )} ∈ \{ 0 , 1 , … , 335 \} , and {N}_{ID}^{( 2 )} ∈ \{ 0 , 1 , 2 \} .$$

The SSS is mapped to the third OFDM symbol of the SSB as illustrated in FIG. 8. The SSS is mapped to sub-carriers 56 to 182 of the SSB in increasing order of n. The UE first receives/detects PSS to get timing information and

$${N}_{ID}^{( 2 )} .$$

Next, the UE can determine the position of the SSS relative to the PSS. Next, the UE receives/detects SSS to get

$${N}_{ID}^{( 1 )} .$$

The physical cell identity (PCI),

$${N}_{ID}^{c e l l} ,$$

is determined by

$${N}_{ID}^{( 1 )} and {N}_{ID}^{( 2 )} ,$$

and is given by:

$${N}_{ID}^{c e l l} = 3 \cdot {N}_{ID}^{( 1 )} + {N}_{ID}^{( 2 )} .$$

In NR, there are 1008 PCIs in the range

$${N}_{ID}^{c e l l} ∈ \{ 0 , 1 , … , 1007 \} .$$

In LTE, there are 504 PCIs.

SSBs are organized in groups or bursts of up to N SSBs, transmitted within half a frame, each SSB within the group or burst has an index i, where i=0, 1, . . . , N−1, within each group or burst of SSBs, the SSBs are time-division multiplexed and arranged in increasing order of i, with increasing time. The SSB indices transmitted are provided by ssb-PositionsInBurst in system information block one (SIB1) or in ServingCellConfigCommon or in SSB-MTC-AdditionalPCI or in LTM-SSB-Config.

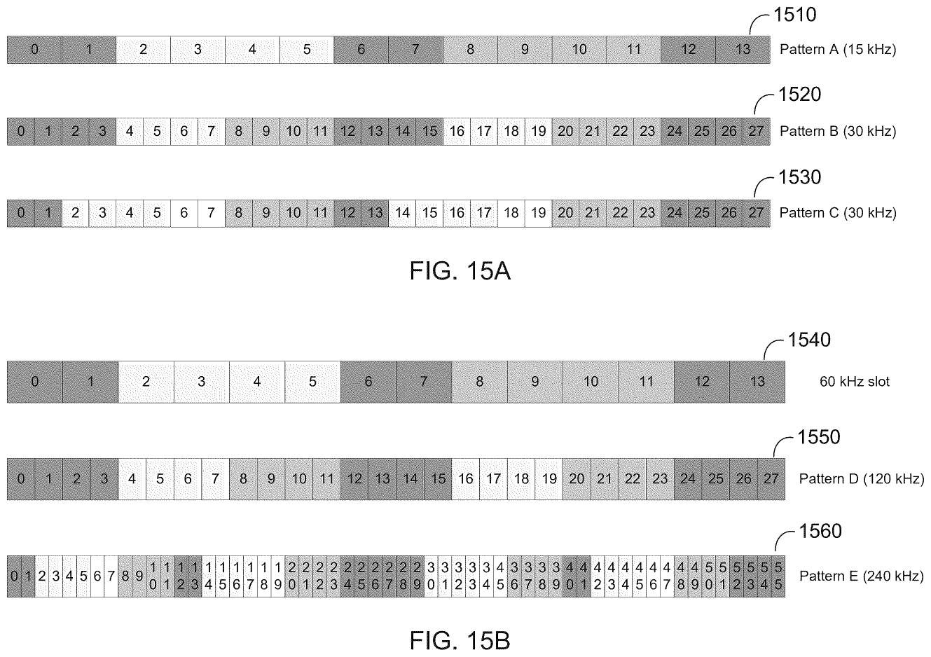

FIGS. 15A and 15B illustrate example SSB structure patterns 1510-1560 at various frequencies according to embodiments of the present disclosure. For example, patterns 1510-1560 can be implemented by BS 102 of FIG. 1. These examples are for illustration only and other embodiments can be used without departing from the scope of the present disclosure.

For carrier frequencies less than or equal to 3 GHZ, N=4. For carrier frequencies in FR1 that are larger than 3 GHz, N=8. For FR1, the reference SCS for the SSB design is 15 kHz. FIG. 15A illustrates the SSB structures within 15 kHz slots that include SSBs. For 15 kHz, there can be two SSBs in a 15 kHz slot, and there is one pattern, e.g., pattern 1510 in FIG. 15A. For 30 kHz, there can be four SSBs in a 15 kHz slot, and there are two patterns, e.g., pattern 1520 and pattern 1530 in FIG. 15A.

For carrier frequencies in FR2, N=64. For FR2, the reference SCS for the SSN design is 60 kHz. FIG. 15B illustrates the SSB structure within a 60 kHz slot that include SSBs (1540). For 120 kHz, there can be four SSBs in a 60 kHz slot, and there is one pattern, e.g., pattern 1550 in FIG. 15B. For 240 kHz, there can be eight SSBs in a 60 kHz slot, and there is one pattern, e.g., pattern 1560 in FIG. 15B.

SSBs are transmitted periodically, where the allowed periodicities are T∈{5, 10, 20, 40, 80, 160} ms. When the SSB periodicity is larger than or equal to 10 ms, SSBs are transmitted in the first half of radio frames with SFN mod T=0, where SFN is the system frame number.

In addition to cell search, SSBs can also be used for connected mode mobility (e.g., handover), idle mode mobility (e.g., cell reselections), inter-RAT mobility to NR, and beam management related procedures, such as new beam acquisition, beam measurements, and beam failure detection and recovery. Each SSB with index i can be associated with a spatial domain filter (or beam).

Within the frequency span of a carrier, multiple SSBs can be transmitted for measurement purposes. The PCIs of SSBs transmitted in different frequency locations can be different. When an SSB is associated with an RMSI, the SSB is referred to as a Cell-Defining SSB (CD-SSB). A PCell is associated to a CD-SSB located on the synchronization raster. When an SSB is not associated with an RMSI, the SSB is referred to as a non-Cell Defining SSB (NCD-SSB). A NCD-SSB can be used to perform RLM, BFD, and RRM measurements and measurements for RA resource selection inside the active DL BWP when the active BWP does not contain the CD-SSB. A UE may be configured with multiple SSBs provided that each BWP is configured with at most one SSB (CD-SSB or NCD-SSB).

As aforementioned, the SS/PBCH block (SSB) has 20 RBs (240 sub-carriers) and includes 4 symbols, hence the bandwidth and duration of the SSB for different sub-carrier spacing is as provided by Table 2 below.

TABLE 2

| Sub-carrier Spacing | SSB BW | SSB Duration | |
|---|---|---|---|
| 15 kHz | 3.6 MHz | 285. 4 | μsec |
| 30 kHz | 7.2 MHz | 142.7 | μsec |
| 120 kHz | 28.8 MHz | 35.7 | μsec |
| 240 kHz | 57.6 MHz | 17.8 | μsec |

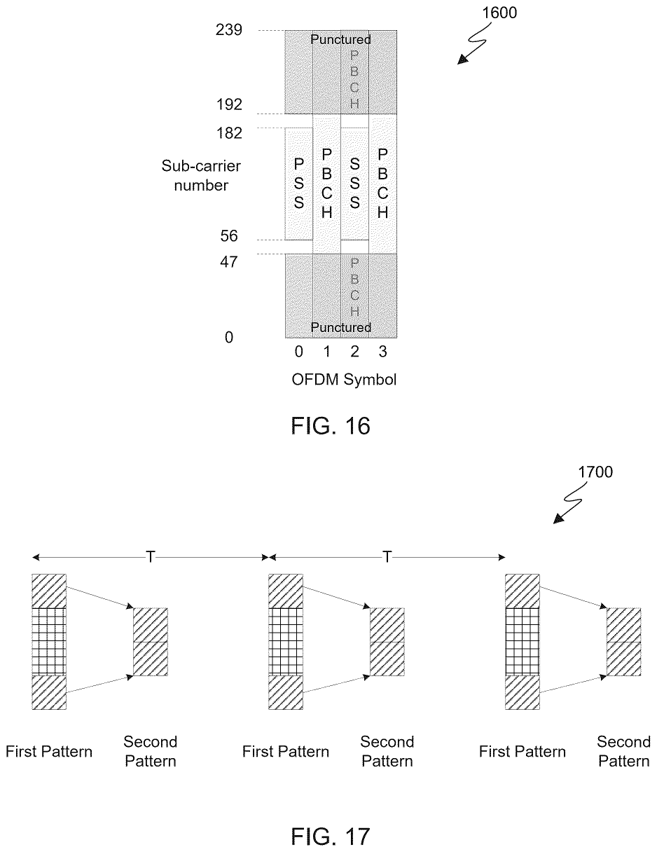

FIG. 16 illustrates an example punctured SSB 1600 according to embodiments of the present disclosure. For example, punctured SSB 1600 can be implemented by BS 102 of FIG. 1. This example is for illustration only and other embodiments can be used without departing from the scope of the present disclosure.

For low channel bandwidth, the BW of the SS/PBCH block (SSB) can exceed the channel BW. To address that issue, Rel-18 NR introduced puncturing of the SS/PBCH block to fit within the allocated channel BW. As illustrated in FIG. 15, for a 3 MHz channel bandwidth with sub-carrier spacing 15 kHz, the SS/PBCH block is punctured equally from both sizes to 12 RBs, i.e., 4 RBs are punctured from both sides. 12 RBs at sub-carrier spacing 15 kHz is 2.16 MHz which can fit within a channel BW of 3 MHz.

In FIG. 16, 4 RBs are punctured from each side, the puncturing does not impact the PSS and SSS, and impacts only the PBCH block of the SSB. No PBCH RBs are used in symbol 2, and the number of PBCH RBs is reduced from 20 to 12 in symbols 1 and 3. Hence, the total number of RBs used for PBCH is reduced from 48 RBs to 24 RBs (half the number of RBs). This can lead to a degradation in performance of roughly 3 dB.

The present disclosure considers a scenario where low-bandwidth UEs and high-bandwidth UEs co-exist in the same cell. An SS/PBCH block design is considered to enable a high-bandwidth UE to access the network with normal performance and, at the same time, to enable a low-bandwidth UE to use the same SS/PBCH block to access the network. As such, the disclosure considers a unified SS/PBCH block design for both low-bandwidth and high-bandwidth UEs. While SS/PBCH block is used as an example, this design by apply to any other channel or signal, to be received by a high bandwidth UE and a low bandwidth UE.

One design choice is to limit the SS/PBCH block BW to be less than or equal to the bandwidth of the low-bandwidth UEs. However, this limits the SS/PBCH block BW for high-bandwidth UEs and can lead to sub-optimal performance for high-bandwidth UEs.

Another design choice is to allow the bandwidth of the SS/PBCH block to be larger than then the maximum reception bandwidth of the low-bandwidth UEs. When receiving the SS/PBCH block, a low-bandwidth UE receives the REs within the UE's reception bandwidth and punctures other REs. However, this can lead to a degradation in performance for low-bandwidth UEs.

FIG. 17 illustrates yet another design choice 1700 for an SSB where high-bandwidth UEs and low-bandwidth UEs access the same cell according to embodiments of the present disclosure. For example, design choice 1700 can be implemented by BS 102 if FIG. 1. This example is for illustration only and other embodiments can be used without departing from the scope of the present disclosure.

As illustrated in FIG. 17, design choice 1700 may have multiple (e.g. two) SS/PBCH block patterns. The first SS/PBCH block pattern can be used by all UEs, while the second SS/PBCH block pattern can be used by low-bandwidth UEs for REs of the SS/PBCH block that are outside the reception bandwidth of a low-bandwidth UE in the first pattern, but are moved to be inside the reception bandwidth of the low-bandwidth UE BW in the second pattern. In one example, the REs that are repeated in the second pattern are the REs of the PBCH as described in this disclosure. In one example, a PSS is included in the second pattern. In one example, a PSS sequence of the second pattern is different from a PSS sequence of the first pattern. In one example, a PSS is not included in the second pattern, for example the second pattern is at a fixed offset from the first pattern.

FIG. 17 illustrates two patterns for SSBs. Both patterns have periodicity T. The first pattern has a larger bandwidth and can be received, at least partially, by all UEs. The first pattern includes an inner part (with vertical/horizontal lines) and an outer part (with tilted lines), as illustrated in FIG. 17. The inner part of the SSB of the first pattern has a BW smaller than or equal to that of the reception bandwidth of a low-bandwidth UEs. High-bandwidth UEs can receive the entire bandwidth of the SSB signal of the first pattern (both parts), while low-bandwidth UEs receive only the inner part of the SSB signal of the first pattern (with vertical/horizontal lines). The second pattern includes the outer REs of the first pattern (with titled lines), and these REs are moved to the inner bandwidth of the SSB of the second pattern. Low-bandwidth UEs receive the SSB of the second pattern that include outer REs of the SSBs of the first pattern. By receiving the SSB of the first pattern (inner part) and the SSB of the second pattern, a low bandwidth UE is able to receive the REs of the SSB over two occasions.

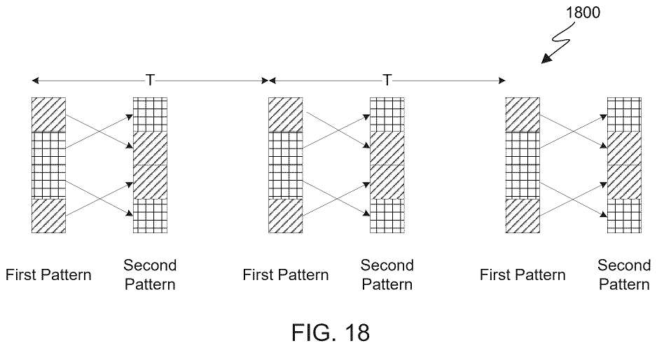

FIG. 18 illustrates yet another design choice 1800 for an SSB where high-bandwidth UEs and low-bandwidth UEs access the same cell according to embodiments of the present disclosure. For example, design choice 1800 can be implemented by BS 102 if FIG. 1. This example is for illustration only and other embodiments can be used without departing from the scope of the present disclosure.

FIG. 18 illustrates an alternative design for two patterns for SSBs. Both patterns have a periodicity T. Both patterns have a larger bandwidth and can be received, at least partially, by all UEs. The first pattern includes an inner part (with vertical/horizontal lines) and an outer part (with tilted lines), as illustrated in FIG. 18. The inner and outer parts of the SSB of the first pattern are flipped/reversed in the SSB of the second pattern. The inner part of the SSB of the first pattern and the inner part of the SSB of the second pattern have a BW that is smaller than or equal to a maximum reception BW of a low-bandwidth UE. High-bandwidth UEs can receive the entire bandwidth of the SSB of the first pattern (both parts) and/or the entire bandwidth of the SSB signal of the second pattern (both parts), while a low-bandwidth UE receives the inner part of the SSB of the first pattern (with vertical/horizontal lines) and the inner part of the SSB of the second pattern (with tilted lines). By receiving the SSB of the first pattern (inner part-vertical/horizontal lines) and the SSB of the second pattern (inner part-tilted lines), a low bandwidth UE is able to receive the REs of the SSB over two occasions.

The present disclosure considers design aspects of the first pattern of the SS/PBCH block and the second pattern of the SS/PBCH block. In some embodiments, there can be more than two SS/PBCH block patterns. For example, if the BW of the SS/PBCH block is N times larger than the maximum reception bandwidth of the low-bandwidth UE, there can be N patterns, wherein a different SS/PBCH block inner signal is used in each one of the N patterns such that, by receiving the N SS/PBCH block patterns, a low-bandwidth UE receives all the REs of the SS/PBCH block.

While the examples of this disclosure use the example of SS/PBCH block as a common signal received by UEs (low-bandwidth UEs and high-bandwidth UEs), the SS/PBCH block can also be replaced by another common signal or channel that is received by low-bandwidth UEs and high-bandwidth UEs, and the bandwidth of the common signal or channel is larger than the maximum reception bandwidth of a low-bandwidth UE.

In addition, the present disclosure provides aspects related to design of a common SS/PBCH block (or other common signals or channels) for high-bandwidth UEs and low-bandwidth UEs:
An instance of an SS/PBCH block (or PBCH or other common signal or channel) is transmitted over multiple occasions, such that the REs within a certain bandwidth (e.g., less than the bandwidth of the low-bandwidth UEs) across all occasions include all REs of the instance of SS/PBCH block.

Replicating the REs of a transmission instance of SS/PBCH block (or PBCH or other common signal or channel) (referred to as first pattern) outside the reception bandwidth of a low-bandwidth UE in a second transmission instance of SS/PBCH block (or PBCH or other common signal or channel) (referred to as second pattern) to be inside the reception bandwidth of a low-bandwidth UE.

In the following, both FDD and TDD are considered as a duplex method for DL and UL signaling. In addition, full duplex (XDD) operation is possible, e.g., sub-band full duplex (SBFD) or single frequency full duplex (SFFD).

Although exemplary descriptions and embodiments to follow assume orthogonal frequency division multiplexing (OFDM) or orthogonal frequency division multiple access (OFDMA), this disclosure can be extended to other OFDM-based transmission waveforms or multiple access schemes such as filtered OFDM (F-OFDM).

This disclosure considers several components that can be used in conjunction or in combination with one another, or can operate as standalone schemes.

In this disclosure, RRC signaling (e.g., configuration by RRC signaling) includes (1) common information provided by common signaling, e.g., this can be system information block (SIB)-based RRC signaling (e.g., SIB1 or other SIB) or (2) RRC dedicated signaling that is sent to a specific UE wherein the information can be common/cell-specific information or dedicated/UE-specific information or (3) UE-group RRC signaling.

In this disclosure MAC CE signaling can be UE-specific e.g., to one UE or can be UE common (e.g., to a group of UEs or to all UEs in a cell). MAC CE signaling can be DL MAC CE signaling or UL MAC CE signaling.

In this disclosure L1 control signaling includes: (1) DL control information (e.g., DCI on PDCCH or DL control information on PDSCH or sequence based signaling, e.g., where specific sequence can convey information) and/or (2) UL control information (e.g., UCI on PUCCH or PUSCH). L1 control signaling be UE-specific e.g., to one UE and can be UE common (e.g., to a group of UEs or to all UEs in a cell).

In this disclosure, configuration can refer to configuration by semi-static signaling (e.g., RRC or SIB signaling). In one example, a configuration can be applicable to multiple transmission instances, until a configuration is received and applied.

In this disclosure, indication can refer to indication by dynamic signaling (e.g., L1 control (e.g., DCI Format) or MAC CE signaling). In one example, an indication can be for an associated occasion(s) (e.g., an occasion or multiple occasions associated with the indication).

In this disclosure a list with N elements can be denoted as L (i), where i can take N values, and L (i) can correspond to the element associated with index i. In one example, i can take N arbitrary values. In one example, i=0, 1, . . . , N−1. In one example, i=1, 2, . . . , N. In one example, i is an identity of an element in the list.

In the present disclosure, the term “activation” describes an operation wherein a UE receives and decodes first information provided by a first signal from the network (or gNB) and based on the first information, the UE determines a starting point in time. The starting point can be a present or a future slot/subframe or symbol and the exact location is either implicitly or explicitly indicated, or is otherwise defined in the system operation or is configured by higher layers. Upon successfully decoding the first information, the UE responds according to an indication provided by the first information. The term “deactivation” describes an operation wherein a UE receives and decodes second information provided by a second signal from the network (or gNB) and based on the second information from the signal, the UE determines a stopping point in time. The stopping point can be a present or a future slot/subframe or symbol and the exact location is either implicitly or explicitly indicated, or is otherwise defined in the system operation or is configured by higher layers. Upon successfully decoding the second information, the UE responds according to an indication provided by the second information. The first signal can be same as the second signal or the first information can be same as the second information, wherein a first part of the information can be associated with an “activation” operation and with first UEs or with first parameters for transmissions/receptions by a UE, and a second part of the information can be associated with a “deactivation” operation and with second UEs or with second parameters for transmissions/receptions by the UE. For example, the second information can be absent, and deactivation can be implicitly derived. For example, when a UE has received an activation information in a previous indication, and is not included among UEs with activation information in a next indication, the UE can determine the latter indication as an implicit deactivation indication.

In this disclosure, a time unit, for example, can be a symbol or a slot or sub-frame or a frame. In one example, a time-unit can be multiple symbols, or multiple slots or multiple sub-frames or multiple frames. In one example, a time-unit can be a sub-slot (e.g., part of a slot). In one example, a time-unit can be specified in units of time, e.g., microseconds, or milliseconds or seconds, etc.

In this disclosure, a frequency-unit, for example, can be a sub-carrier or a resource block (RB) or a sub-channel, wherein a sub-channel is a group or RBs, or a bandwidth part (BWP). In one example, a frequency-unit can be multiple sub-carriers, or multiple RBs or multiple sub-channels. In one example, a frequency-unit can be a sub-RB (e.g., part of a RB). A frequency-unit can be specified in units of frequency, e.g., Hz, or kHz or MHz, etc.

In this disclosure Msg5 refers to the message transmitted by the UE in response to Msg4. For example, Msg5 can be connection setup complete or resume complete.

Terminology such as TCI, TCI states, SpatialRelationInfo, target RS, reference RS, Msg1, Msg2, Msg3, Msg4, Msg5, MsgA, MsgB and other terms is used for illustrative purposes and is therefore not normative. Other terms that refer to same functions can also be used.

Terminology such as SS/PBCH block, PSS, SSS, PBCH, target RS, reference RS, and other terms is used for illustrative purposes and is therefore not normative. Other terms that refer to same functions can also be used.

A “reference RS” (e.g., reference source RS) corresponds to a set of characteristics of a DL beam or an UL TX beam, such as a direction, a precoding/beamforming, a number of ports, and so on. For instance, the UE can receive a source RS index/ID in a TCI state assigned to (or associated with) a DL transmission (and/or UL transmission), the UE applies the known characteristics of the source RS to the assigned DL transmission (and/or UL transmission). The source RS can be received and measured by the UE (in this case, the source RS is a downlink measurement signal such as NZP CSI-RS and/or SSB) with the result of the measurement used for calculating a beam report (e.g., including at least one L1-RSRP/L1-SINR accompanied by at least one CRI or SSBRI). As the NW/gNB receives the beam report, the NW can be better equipped with information to assign a particular DL (and/or UL) TX beam to the UE. Optionally or alternatively, the source RS can be transmitted by the UE (in this case, the source RS is an uplink measurement signal such as SRS). As the NW/gNB receives the source RS, the NW/gNB can measure and calculate the needed information to assign a particular DL (or/and UL) TX beam to the UE, for example in case of channel reciprocity.

In this disclosure, DCI Format is used for L1 control information in the DL direction from gNB to UE. DCI Format (i.e., L1 control information) can be signal stage/part control information or two stage/part control information. In one example, the DCI format can be carried on a physical downlink control channel (PDCCH). In one example, DCI format can be carried on a physical downlink shared channel (PDSCH). In one example, DCI can be split between PDCCH (e.g., for a first part) and PDSCH (e.g. for a second part).

In this disclosure, a higher layer message (e.g., SIB-based or RRC-based or MAC CE-based) can be carried by a physical downlink shared channel (PDSCH). In one example, the PDSCH can be scheduled by a DCI format.

In one example, the controlResourceSetZero provided by the MIB can indicate two sets of resources for a CORESET (or resources are provided for two respective CORESETs).
A first set of resources

$${N}_{s y m b 1}^{C O R E S E T} \times {N}_{R B 1}^{C O R E S E T} starting at {N}_{start 1}^{C O R E S E T} ,$$

for a first type or group of users (e.g., standard users with a large bandwidth), wherein

$${N}_{symb 1}^{C O R E S E T}$$

is the duration of the first configuration of the CORESET in time units (e.g., symbols),

$${N}_{RB 1}^{CORESET}$$

is the frequency span of the first configuration of the CORESET in frequency units (e.g., resource blocks (RBs)), and

$${N}_{start 1}^{CORESET}$$

is the starting location of the first configuration of the CORESET in frequency units (e.g., sub-carriers and/or RBs).
A second set of resources

$${N}_{s y m b 2}^{C O R E S E T} \times {N}_{R B 2}^{C O R E S E T} starting at {N}_{start 2}^{C O R E S E T} ,$$

for a second type of users (e.g., low bandwidth users), wherein

$${N}_{s y m b 2}^{C O R E S E T}$$

is the duration of the second configuration of the CORESET in time units (e.g., symbols),

$${N}_{R B 2}^{C O R E S E T}$$

is the frequency span of the first configuration of the CORESET in frequency units (e.g., resource blocks (RBs)), and

$${N}_{start 2}^{CORESET}$$

is the starting location of the second configuration of the CORESET in frequency units (e.g., sub-carriers and/or RBs).

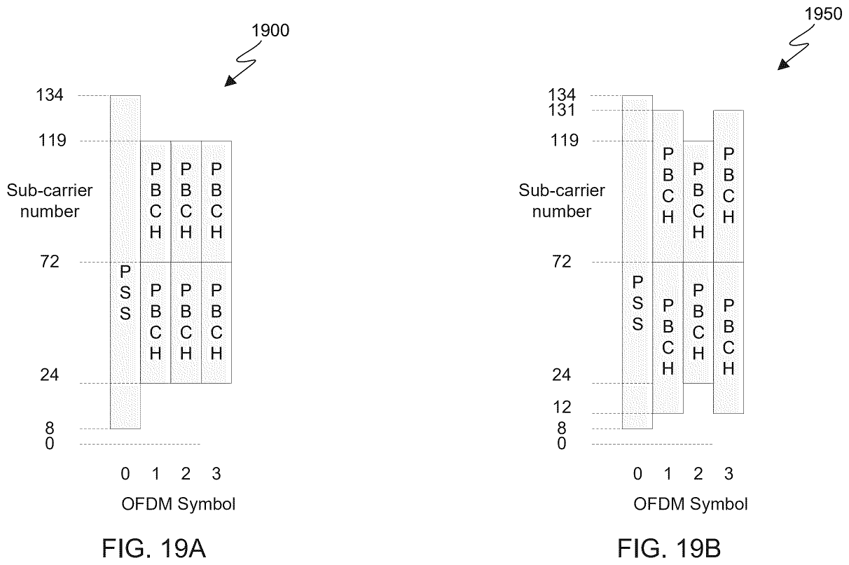

FIGS. 19A and 19B illustrate alternative example SSBs 1900 and 1950, respectively, that can be utilized in a cell search procedure according to embodiments of the present disclosure. For example, SSBs 1900 and 1950 can be transmitted by BS 102 or received by any one of the UEs 111-116 of FIG. 1. These examples are for illustration only and other embodiments can be used without departing from the scope of the present disclosure.

In one example, as illustrated in FIG. 19A, a second SS/PBCH block (e.g., SSB 1900) includes 4 symbols, wherein:
The first symbol includes the PSS, occupying 127 sub-carriers close to the middle (e.g., in the middle 12 RBs, e.g., from subcarrier #8 to #134). The remaining sub-carriers are set to 0.
The third symbol includes PBCH occupying 8 RBs, wherein the 8 RBs are the 8 RBs of PBCH in the third symbol of FIG. 8. In one example, PBCH of sub-carriers 0 to 47 of FIG. 8, are mapped to PBCH of sub-carriers 24 to 71 of FIG. 19A, and PBCH of sub-carriers 192 to 239 of FIG. 8, are mapped to PBCH of sub-carriers 72 to 119 of FIG. 19A. In one example, PBCH of sub-carriers 0 to 47 of FIG. 8, are mapped to PBCH of sub-carriers 72 to 119 of FIG. 19A, and PBCH of sub-carriers 192 to 239 of FIG. 8, are mapped to PBCH of sub-carriers 24 to 71 of FIG. 19A.
The second and fourth symbols includes PBCH occupying 8 RBs, wherein the 8 RBs are the outer 8 RBs of PBCH of the second and fourth symbols of FIG. 8, respectively. In one example, PBCH of sub-carriers 0 to 47 of FIG. 8 are mapped to PBCH of sub-carriers 24 to 71 of FIG. 19A, and PBCH of sub-carriers 192 to 239 of FIG. 8, are mapped to PBCH of sub-carriers 72 to 119 of FIG. 19A. In one example, PBCH of sub-carriers 0 to 47 of FIG. 8, are mapped to PBCH of sub-carriers 72 to 119 of FIG. 19A and PBCH of sub-carriers 192 to 239 of FIG. 8, are mapped to PBCH of sub-carriers 24 to 71 of FIG. 19A.

In one example, as illustrated in FIG. 19B, a second SS/PBCH block (e.g., SSB 1950) includes 4 symbols, wherein:
The first symbol includes the PSS, occupying 127 sub-carriers close to the middle (e.g., in the middle 12 RBs, e.g., from subcarrier #8 to #134). The remaining sub-carriers are set to 0.
The third symbol includes PBCH occupying 8 RBs, wherein the 8 RBs are the 8 RBs of PBCH the third symbol of FIG. 8. In one example, PBCH of sub-carriers 0 to 47 of FIG. 8, are mapped to PBCH of sub-carriers 24 to 71 of FIG. 19B, and PBCH of sub-carriers 192 to 239 of FIG. 8, are mapped to PBCH of sub-carriers 72 to 119 of FIG. 19B. In one example, PBCH of sub-carriers 0 to 47 of FIG. 8, are mapped to PBCH of sub-carriers 72 to 119 of FIG. 19B, and PBCH of sub-carriers 192 to 239 of FIG. 8, are mapped to PBCH of sub-carriers 24 to 71 of FIG. 19B.
The second and fourth symbols includes PBCH occupying 10 RBs (e.g., half the 20 RBs of SS/PBCH Block), wherein the 10 RBs are the outer 10 RBs of PBCH of the second and fourth symbols of FIG. 8, respectively. In one example, PBCH of sub-carriers 0 to 59 of FIG. 8, are mapped to PBCH of sub-carriers 12 to 71 of FIG. 19B, and PBCH of sub-carriers 180 to 239 of FIG. 8, are mapped to PBCH of sub-carriers 72 to 131 of FIG. 19B. In one example, PBCH of sub-carriers 0 to 59 of FIG. 8, are mapped to PBCH of sub-carriers 72 to 131 of FIG. 19B, and PBCH of sub-carriers 180 to 239 of FIG. 8, are mapped to PBCH of sub-carriers 12 to 71 of FIG. 19B.

In one example, the first SS/PBCH block (e.g., SSB 800 of FIG. 8) is used for the SS/PBCH block of the first pattern and the second SS/PBCH block (e.g., SSB 1900 or 1950 of FIGS. 19A and 19B) is used for the SS/PBCH block of the second pattern. In one example, a first sequence is used for the PSS of the first SS/PBCH block (e.g., SSB 800 of FIG. 8), and a second sequence is used for PSS of the second SS/PBCH block (e.g., SSB 1900 or 1950 of FIGS. 19A and 19B).

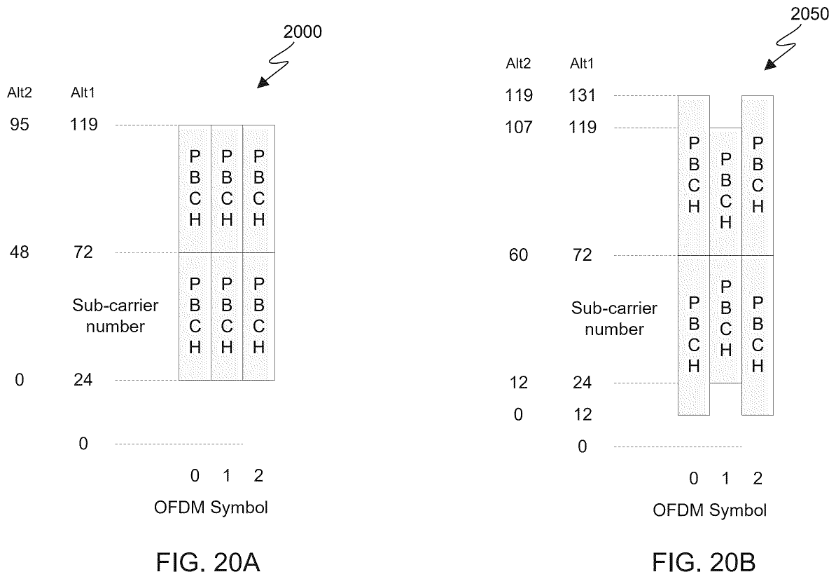

FIGS. 20A and 20B illustrate more alternative example SSBs 2000 and 2050, respectively, that can be utilized in a cell search procedure according to embodiments of the present disclosure. For example, SSBs 2000 and 2050 can be transmitted by BS 102 or received by any one of the UEs 111-116 of FIG. 1. These examples are for illustration only and other embodiments can be used without departing from the scope of the present disclosure.

In one example, as illustrated in FIG. 20A, a second SS/PBCH block (e.g. SSB 2000) includes 3 symbols, wherein:
The second symbol includes PBCH occupying 8 RBs, wherein the 8 RBs are the 8 RBs of PBCH of the third symbol of FIG. 8. In one example, PBCH of sub-carriers 0 to 47 of FIG. 8, are mapped to PBCH of sub-carriers 24 to 71 of FIG. 20A (Alt1), and PBCH of sub-carriers 192 to 239 of FIG. 8, are mapped to PBCH of sub-carriers 72 to 119 of FIG. 20A (Alt 1). In one example, PBCH of sub-carriers 0 to 47 of FIG. 8, are mapped to PBCH of sub-carriers 0 to 47 of FIG. 20A (Alt2), and PBCH of sub-carriers 192 to 239 of FIG. 8, are mapped to PBCH of sub-carriers 48 to 95 of FIG. 20A (Alt 2). In one example, PBCH of sub-carriers 0 to 47 of FIG. 8, are mapped to PBCH of sub-carriers 72 to 119 of FIG. 20A (Alt 1), and PBCH of sub-carriers 192 to 239 of FIG. 8, are mapped to PBCH of sub-carriers 24 to 71 of FIG. 20A (Alt 1). In one example, PBCH of sub-carriers 0 to 47 of FIG. 8, are mapped to PBCH of sub-carriers 48 to 95 of FIG. 20A (Alt 2), and PBCH of sub-carriers 192 to 239 of FIG. 8, are mapped to PBCH of sub-carriers 0 to 47 of FIG. 20A (Alt 2).
The first and third symbols include PBCH occupying 8 RBs, wherein the 8 RBs are the outer 8 RBs of PBCH of the second and fourth symbols of FIG. 8, respectively. In one example, PBCH of sub-carriers 0 to 47 of FIG. 8, are mapped to PBCH of sub-carriers 24 to 71 of FIG. 20A (Alt 1), and PBCH of sub-carriers 192 to 239 of FIG. 8, are mapped to PBCH of sub-carriers 72 to 119 of FIG. 20A (Alt 1). In one example, PBCH of sub-carriers 0 to 47 of FIG. 8, are mapped to PBCH of sub-carriers 0 to 47 of FIG. 20A (Alt 2), and PBCH of sub-carriers 192 to 239 of FIG. 8, are mapped to PBCH of sub-carriers 48 to 95 of FIG. 20A (Alt 2). In one example, PBCH of sub-carriers 0 to 47 of FIG. 8, are mapped to PBCH of sub-carriers 72 to 119 of FIG. 20A (Alt 1), and PBCH of sub-carriers 192 to 239 of FIG. 8, are mapped to PBCH of sub-carriers 24 to 71 of FIG. 20A (Alt 1). In one example, PBCH of sub-carriers 0 to 47 of FIG. 8, are mapped to PBCH of sub-carriers 48 to 95 of FIG. 20A (Alt 2), and PBCH of sub-carriers 192 to 239 of FIG. 8, are mapped to PBCH of sub-carriers 0 to 47 of FIG. 20A (Alt 2).

In one example, as illustrated in FIG. 20B, a second SS/PBCH block (e.g., SSB 2050) includes 3 symbols, wherein:
The second symbol includes PBCH occupying 8 RBs, wherein the 8 RBs are the 8 RBs of PBCH of the third symbol of FIG. 8. In one example, PBCH of sub-carriers 0 to 47 of FIG. 8, are mapped to PBCH of sub-carriers 24 to 71 of FIG. 20B (Alt1), and PBCH of sub-carriers 192 to 239 of FIG. 8, are mapped to PBCH of sub-carriers 72 to 119 of FIG. 20B (Alt 1). In one example, PBCH of sub-carriers 0 to 47 of FIG. 8, are mapped to PBCH of sub-carriers 12 to 59 of FIG. 20B (Alt2), and PBCH of sub-carriers 192 to 239 of FIG. 8, are mapped to PBCH of sub-carriers 60 to 107 of FIG. 20B (Alt 2). In one example, PBCH of sub-carriers 0 to 47 of FIG. 8, are mapped to PBCH of sub-carriers 72 to 119 of FIG. 20B (Alt 1), and PBCH of sub-carriers 192 to 239 of FIG. 8, are mapped to PBCH of sub-carriers 24 to 71 of FIG. 20B (Alt 1). In one example, PBCH of sub-carriers 0 to 47 of FIG. 8, are mapped to PBCH of sub-carriers 60 to 107 of FIG. 20B (Alt 2), and PBCH of sub-carriers 192 to 239 of FIG. 8, are mapped to PBCH of sub-carriers 12 to 59 of FIG. 20B (Alt 2).
The first and third symbols includes PBCH occupying 10 RBs (e.g., half the 20 RBs of SS/PBCH Block), wherein the 10 RBs are the outer 10 RBs of PBCH of the second and fourth symbols of FIG. 8, respectively. In one example, PBCH of sub-carriers 0 to 59 of FIG. 8, are mapped to PBCH of sub-carriers 12 to 71 of FIG. 20B (Alt 1), and PBCH of sub-carriers 180 to 239 of FIG. 8, are mapped to PBCH of sub-carriers 72 to 131 of FIG. 20B (Alt 1). In one example, PBCH of sub-carriers 0 to 59 of FIG. 8, are mapped to PBCH of sub-carriers 0 to 59 of FIG. 20B (Alt 2), and PBCH of sub-carriers 180 to 239 of FIG. 8, are mapped to PBCH of sub-carriers 60 to 119 of FIG. 20B (Alt 2). In one example, PBCH of sub-carriers 0 to 59 of FIG. 8, are mapped to PBCH of sub-carriers 72 to 131 of FIG. 20B (Alt 1), and PBCH of sub-carriers 180 to 239 of FIG. 8, are mapped to PBCH of sub-carriers 12 to 71 of FIG. 20B (Alt 1). In one example, PBCH of sub-carriers 0 to 59 of FIG. 8, are mapped to PBCH of sub-carriers 60 to 119 of FIG. 20B (Alt 2), and PBCH of sub-carriers 180 to 239 of FIG. 8, are mapped to PBCH of sub-carriers 0 to 59 of FIG. 20B (Alt 2).

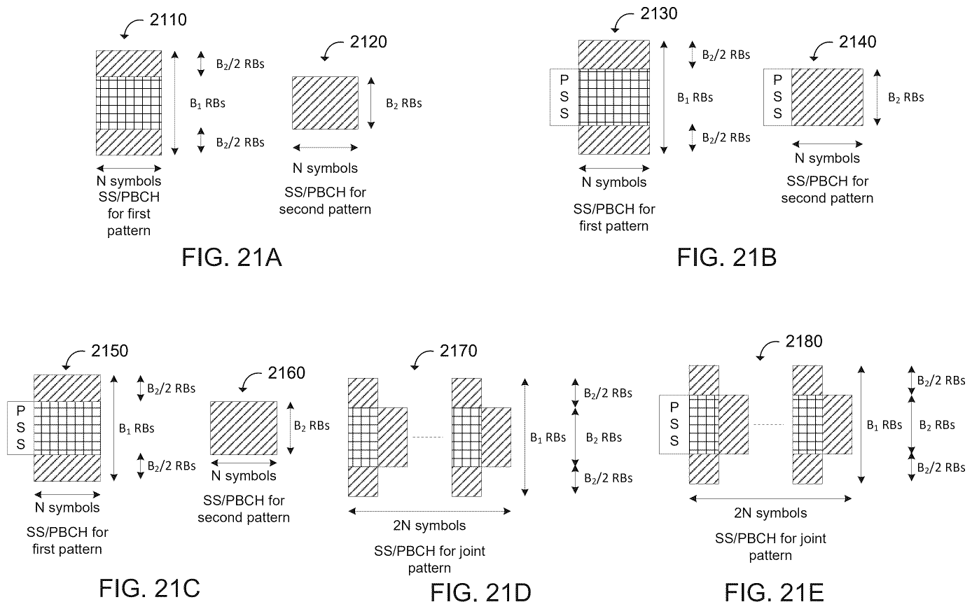

FIGS. 21A-21E illustrate example SSBs 2110-2180 (i.e., SS/PBCH blocks 2110-2180) with various patterns according to embodiments of the present disclosure. For example, SS/PBCH blocks 2110-2180 can be transmitted by BS 102 or received by any one of the UEs 111-116 of FIG. 1. These examples are for illustration only and other embodiments can be used without departing from the scope of the present disclosure.

In one example, as illustrated in FIG. 21A, SS/PBCH blocks 2110 and 2120 (or other common signal/channel) include N symbols. The SS/PBCH block 2110 (or common signal/channel) of the first pattern spans a bandwidth B₁ RBs. The SS/PBCH block 2120 (or common signal/channel) of the second pattern spans a bandwidth B₂ RBs, where B₁>B₂. In one example, the B₂ RBs of a symbol of the SS/PBCH block 2120 (or common signal/channel) of the second pattern, are the: (1) the

$$\frac{{B}_{2}}{2} or ⌈ \frac{{B}_{2}}{2} ⌉ or ⌊ \frac{{B}_{2}}{2} ⌋$$

lower RBs of the B₁ RBs of a corresponding symbol of the SS/PBCH block 2110 (or common signal/channel) of first pattern, and (2) the

$$\frac{{B}_{2}}{2} or ⌈ \frac{{B}_{2}}{2} ⌉ or ⌊ \frac{{B}_{2}}{2} ⌋ ,$$

respectively, upper RBs of the B₁ RBs of the corresponding symbol of the SS/PBCH block 2110 (or common signal/channel) of the first pattern. In one example, B₂≈B₁/2.

In one example, as illustrated in FIG. 21B, SS/PBCH blocks 2130 and 2140 include N+1 symbols, wherein the first symbol of each SS/PBCH block is a PSS. In one example, different sequences are used for a PSS symbol of the first SS/PBCH block pattern and of the second SS/PBCH block pattern. In one example, PSS symbol of SS/PBCH block 2130 of first pattern and SS/PBCH block 2140 of the second pattern use a same sequence. The remaining N symbols of the SS/PBCH block 2130 of the first pattern span a bandwidth of B₁ RBs. The remaining N symbols of the SS/PBCH block 2140 of the second pattern span a bandwidth of B₂ RBs, where B₁>B₂. In one example, the B₂ RBs of a symbol of the N symbols of the SS/PBCH block 2140 of the second pattern are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of the SS/PBCH block 2130 of first pattern, and (2) the

$$\frac{{B}_{2}}{2} , or the ⌈ \frac{{B}_{2}}{2} ⌉ , or the ⌊ \frac{{B}_{2}}{2} ⌋ ,$$

respectively, upper RBs of the B₁ RBs of the corresponding symbol of the SS/PBCH block 2130 of first pattern. In one example, B₂≈B₁/2.

In one example, an SS/PBCH block of the first pattern includes N_{P}+N_{S}+N_{B} symbols, wherein N_{P} is the number of PSS symbols, and N_{S} is the number of SSS symbols and Ng is the number of PBCH symbols. In one example, N_{P}=1. In one example, N_{S}=1. In one example, N_{P}=N_{S}=0, i.e., only PBCH symbols in the first pattern and second pattern, the PSS and SSS symbols are transmitted separately. In one example, the SS/PBCH block of the second pattern includes N_{P}+N_{B} symbols, i.e., symbols for PSS and PBCH respectively. In one example, a first sequence is used for the PSS of the first pattern, and a second sequence is used for the PSS of the second pattern. The N_{B} PBCH symbols of the first pattern span a bandwidth B₁ RBs. The N_{B} PBCH symbols of the second pattern span a bandwidth B₂ RBs, where B₁>B₂. In one example, there is a one-to-one correspondence between the N_{B} PBCH symbols of the first pattern and the N_{B} PBCH symbols of the second pattern. In one example, the B₂ RBs of a symbol of the Ng PBCH symbols of the second pattern, are the: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding PBCH symbol of the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding PBCH symbol of first pattern. In one example, B₂≈B₁/2.

In one example, as illustrated in FIG. 21C, an SS/PBCH block 2150 of the first pattern includes N+1 symbols, wherein the first symbol of the SS/PBCH block 2150 of the first pattern is a PSS. The SS/PBCH block 2160 of the second pattern includes N symbols. The remaining N symbols of the SS/PBCH block 2150 of the first pattern span a bandwidth B₁ RBs. The N symbols of the SS/PBCH block 2160 of the second pattern span a bandwidth B₂ RBs, where B₁>B₂. In one example, there is a one-to-one correspondence between the remaining N symbols of the first pattern and the N symbols of the second pattern. In one example, the B₂ RBs of a symbol of the N symbols of the SS/PBCH block 2160 of the second pattern, are the: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of the SS/PBCH block 2150 of the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the SS/PBCH block 2150 of first pattern. In one example, B₂≈B₁/2.

In one example, an SS/PBCH block of the first pattern includes N_{P}+N_{S}+N_{B} symbols, wherein N_{P} is the number of PSS symbols, and N_{S} is the number of SSS symbols and N_{B} is the number of PBCH symbols. In one example, N_{P}=1. In one example, N_{S}=1. In one example, N_{P}=N_{S}=0, i.e., only PBCH symbols in the first pattern and second pattern, the PSS and SSS symbols are transmitted separately. In one example, the SS/PBCH block of the second pattern includes N_{B} symbols, i.e., symbols for PBCH. The Ng PBCH symbols of the first pattern span a bandwidth B₁ RBs. The N_{B} PBCH symbols of the second pattern span a bandwidth B₂ RBs, where B₁>B₂. In one example, there is a one-to-one correspondence between the N PBCH symbols of the first pattern and the N_{B} PBCH symbols of the second pattern. In one example, the B₂ RBs of a symbol of the Ng PBCH symbols of the second pattern, are the: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding PBCH symbol of the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding PBCH symbol of first pattern. In one example, B₂≈B₁/2.

In one example, as illustrated in FIG. 21D, a joint SS/PBCH block 2170 (or other common signal/channel) of the first pattern and of the second pattern includes 2N symbols. In one example, the symbols corresponding to the first pattern are the even symbols, and the symbols corresponding to the second pattern are the odd symbols. In one example, the symbols corresponding to the first pattern are the odd symbols, and the symbols corresponding to the second pattern are the even symbols. In one example, the N symbols corresponding to the first pattern are first followed by the N symbols corresponding to the second pattern or vice versa. The N symbols corresponding to the first pattern span a bandwidth B₁ RBs. The N symbols corresponding to the second pattern span a bandwidth B₂ RBs, where B₁>B₂. In one example, the B₂ RBs of a symbol of N symbols corresponding to the second pattern, are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of N symbols corresponding to the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the N symbols corresponding to the first pattern. In one example, B₂≈B₁/2.

In one example, as illustrated in FIG. 21E, a joint SS/PBCH block 2180 of the first pattern and the second pattern includes 1+2N symbols, wherein the first symbol of the SS/PBCH block 2180 is a PSS. The remaining 2N symbols of the SS/PBCH block 2180 correspond to N symbols of the first pattern and to N symbols of the second pattern. In one example, the symbols corresponding to the first pattern are the even symbols, and the symbols corresponding to the second pattern are the odd symbols. In one example, the symbols corresponding to the first pattern are the odd symbols, and the symbols corresponding to the second pattern are the even symbols. In one example, the N symbols corresponding to the first pattern are first followed by the N symbols corresponding to the second pattern or vice versa. The N symbols corresponding to the first pattern span a bandwidth B₁ RBs. The N symbols corresponding to the second pattern span a bandwidth B₂ RBs, where B₁>B₂. In one example, the B₂ RBs of a symbol of N symbols corresponding to the second pattern, are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of N symbols corresponding to the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the N symbols corresponding to the first pattern. In one example, B₂≈B₁/2.

In one example, a joint SS/PBCH block of the first pattern and the second pattern includes N_{P}+N_{S}+2N_{B} symbols, wherein N_{P} is the number of PSS symbols, and N_{S} is the number of SSS symbols and Ng is the number of PBCH symbols, the PBCH symbols are repeated twice once for the first pattern and once for the second pattern. In one example, N_{P}=1. In one example, N_{S}=1. In one example, N_{P}=N_{S}=0, i.e., only PBCH symbols in the first pattern and second pattern, the PSS and SSS symbols are transmitted separately. In one example, a symbol corresponding to the first pattern is first followed by a symbol corresponding to the second pattern. In one example, a symbol corresponding to the second pattern is first followed by a symbol corresponding to the first pattern.

The N_{B} symbols of PBCH corresponding to the first pattern span a bandwidth B₁ RBs. The N_{B} symbols of PBCH corresponding to the second pattern span a bandwidth B₂ RBs, where B₁>B₂. In one example, the B₂ RBs of a symbol of N_{B} symbols of PBCH corresponding to the second pattern, are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of N_{B} symbols of PBCH corresponding to the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the N_{B} symbols of PBCH corresponding to the first pattern. In one example, B₂≈B₁/2.

In one of the examples in FIGS. 21A-21E, the center frequency of the SS/PBCH block (or other common signal/channel) of the first pattern and the center frequency of the SS/PBCH block (or other common signal/channel) of the second pattern are the same.

In a variant of the examples of FIGS. 21A-21E, the SS/PBCH block (or other common signal/channel) of the first pattern spans B₁ RBs, and there are M SS/PBCH block (or other common signal/channel) patterns. The SS/PBCH block (or other common signal/channel) of the second pattern spans B₂ RBs, . . . , and the SS/PBCH block (or other common signal/channel) of the M-th pattern spans BM RBs. In one example, B₂, . . . , B_{M} are non-overlapping RBs in the B₁ RBs of the SS/PBCH block (or other common signal/channel) of first pattern. In one example, B₂, . . . , B_{M} correspond to the outer RBs of the RBs of the SS/PBCH block (or other common signal/channel) of first pattern. In one example, B₂≈ . . . ≈B_{M}≈B₁/M. In one example, the center frequencies of the SS/PBCH blocks (or other common signal/channel) of the M patterns are the same. In one example, the B₁−(B₂+ . . . +B_{M}) inner RBs of the SS/PBCH block (or other common signal/channel) of the first pattern, the B₂ RBs of the SS/PBCH block (or other common signal/channel) of the second pattern, . . . , and the B_{M} RBs of the SS/PBCH block (or other common signal/channel) of the M-th pattern are within the maximum reception bandwidth of a low bandwidth UE. A reception of these RBs across the M SS/PBCH block (or other common signal/channel) patterns is equivalent to a reception of the B₁ RBs of the SS/BPCH block (or other common signal/channel) of the first pattern.

In one example, the PBCH payload (e.g., master information block (MIB) and other information included in the PBCH transport block) is encoded and rate matched to obtain code modulation symbols for PBCH. The coded modulation symbols are mapped in a first manner to REs of the first pattern, and are mapped in a second manner to REs of the second pattern, . . . and are mapped in a Mth manner to REs of the Mth pattern. The mapping can be such that each coded modulation symbol for PBCH is mapped to REs within the reception bandwidth of a low-bandwidth UE in the first pattern or the second pattern . . . or Mth pattern as described in the examples of this disclosure. In one example, M=2. In one example, a low bandwidth UE receiving the PBCH (or SS/PBCH) receives REs within the low bandwidth UE reception bandwidth from the first pattern and corresponding instances of the second pattern, . . . the Mth pattern, combines the REs (e.g., to get the full set of REs of the PBCH (or SS/PBCH block), and proceeds with the decoding of the PBCH (or SS/PBCH block).

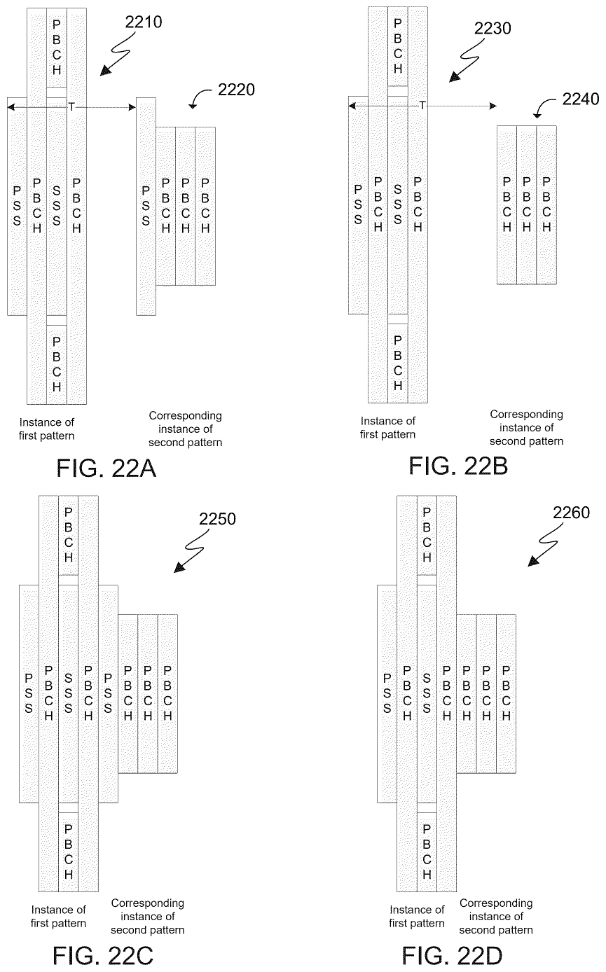

FIGS. 22A-22D illustrate alternative example SSBs 2210-2260 (i.e., SS/PBCH blocks 2210-2260) with various patterns according to embodiments of the present disclosure. For example, SS/PBCH blocks 2210-2260 can be transmitted by BS 102 or received by any one of the UEs 111-116 of FIG. 1. These examples are for illustration only and other embodiments can be used without departing from the scope of the present disclosure.

In one example, as illustrated in FIGS. 22A and 22B, an instance of the second pattern is at a time T after a corresponding instance of the first pattern, wherein the time T can be in time-units as mentioned herein. In one example, T can be units of time (e.g., milli-seconds). In one example T can be in symbols and/or slots and/or sub-frames and/or frames for an SCS associated with the SS/PBCH block. In one example, Tis from the start of an instance of a first pattern to the start of a corresponding instance of a second pattern, as illustrated in FIGS. 22A and 22B. In one example, T is from the start of an instance of a first pattern to the end of a corresponding instance of a second pattern. In one example, T is from the end of an instance of a first pattern to the start of a corresponding instance of a second pattern. In one example, T is from the end of an instance of a first pattern to the end of a corresponding instance of a second pattern. In FIG. 22A, the second SS/PBCH pattern has 4 symbols, e.g., as illustrated in FIG. 19A. In FIG. 22B, the second SS/PBCH block pattern has 3 symbols, e.g., as illustrated in FIG. 20A.

In one example, an instance of the second pattern is after a corresponding instance of the first pattern as illustrated in FIG. 22C and FIG. 22D. In FIG. 22C, the second SS/PBCH pattern has 4 symbols, e.g., as illustrated in FIG. 19A. In FIG. 22D, the second SS/PBCH pattern has 3 symbols, e.g., as illustrated in FIG. 20A. In one example, the center frequency of the SS/PBCH block of the first pattern and the center frequency of the SS/PBCH block of the second pattern are aligned, as illustrated in FIGS. 22A-22D.

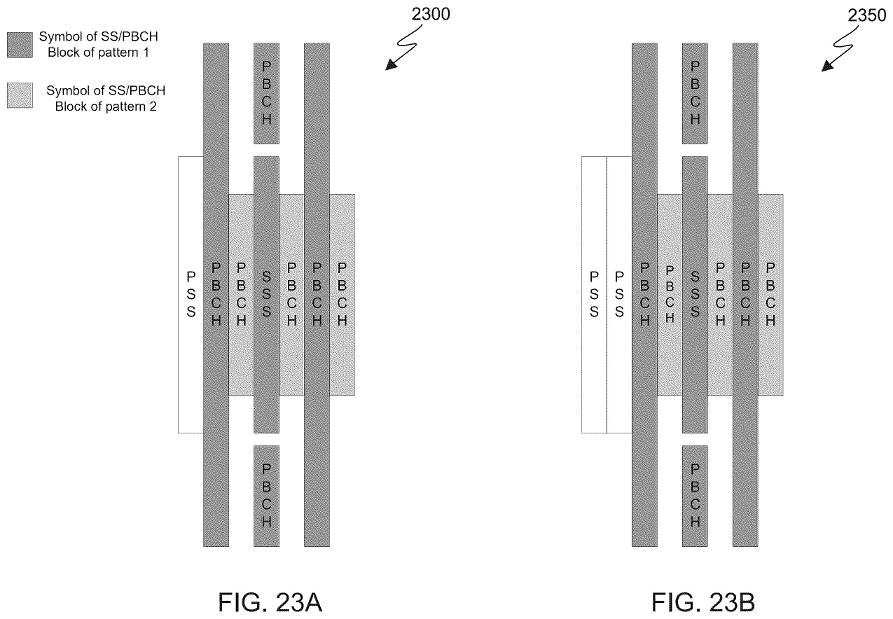

FIGS. 23A and 23B illustrate more alternative example SSBs 2300 and 2350 (i.e., SS/PBCH blocks 2300 and 2350) with various patterns according to embodiments of the present disclosure. For example, SS/PBCH blocks 2300 and 2350 can be transmitted by BS 102 or received by any one of the UEs 111-116 of FIG. 1. These examples are for illustration only and other embodiments can be used without departing from the scope of the present disclosure.

In one example, as illustrated in FIG. 23A, the symbols of an instance of the first SS/PBCH block pattern and a corresponding instance of the second SS/PBCH block pattern are interleaved. Further, in FIG. 23A, the combined SS/PBCH block 2300 includes 7 symbols:
A PSS symbol. In one example, the PSS symbol may belong to the first pattern. In one example, the PSS symbol may be common to the first pattern and the second pattern.
The second symbol of the SS/PBCH block of the first pattern.
The second symbol of the SS/PBCH block of the second pattern of FIG. 19A, or the first symbol of the SS/PBCH block of the second pattern of FIG. 20A.
The third symbol of the SS/PBCH block of the first pattern.
The third symbol of the SS/PBCH block of the second pattern of FIG. 19A or the second symbol of the SS/PBCH block of the second pattern of FIG. 20A.
The fourth symbol of the SS/PBCH block of the first pattern.
The fourth symbol of the SS/PBCH block of the second pattern of FIG. 19A, or the third symbol of the SS/PBCH block of the second pattern of FIG. 20A.

In a variant example, as illustrated in FIG. 23B, the combined SS/PBCH block 2350 includes 8 symbols. In one example, the structure of the combined SS/PBCH block 2350 of FIG. 23B is similar to the structure of the combined SS/PBCH block of FIG. 23A, except that that PSS symbol is repeated twice. In one example, a same PSS sequence is used for both PSS symbols. In one example, a first PSS sequence is used for the first PSS symbol, and a second PSS sequence is used for the second PSS symbol.

The aforementioned example can be extended to SS/PBCH block (or other common signal/channel) following the examples of FIG. 19B/FIG. 20B/FIGS. 21A-21E.

With reference once again to FIGS. 21A-21E, in one example, a UE is a low-bandwidth UE. The network transmits an SS/PBCH block (or PBCH channel or other common signal/channel) associated with a first pattern, and an SS/PBCH block (or PBCH channel or other common signal/channel) associated with a second pattern, for example, as illustrated in FIGS. 21A-21E. In one example, the SS/PBCH block (or PBCH channel or other common signal/channel) associated with the first pattern has a PSS symbol with a first sequence, and the SS/PBCH block (or PBCH channel or other common signal/channel) associated with the second pattern has a PSS symbol with a second sequence for example as illustrated in FIG. 21B. In one example, the SS/PBCH block (or PBCH channel or other common signal/channel) associated with the first pattern has a PSS symbol, and the SS/PBCH block (or PBCH channel or other common signal/channel) associated with the second pattern does not have a PSS symbol for example as illustrated in FIG. 21C. As aforementioned, the SS/PBCH block of the first pattern, can have N_{P}+N_{S}+N_{B} symbols, and the SS/PBCH block of the second pattern can have N_{B} symbols or N_{P}+N_{B} symbols. In one example, when N_{P}=N_{S}=0, the PBCH of the first pattern and the PBCH of the second pattern is at a fixed offset, e.g., based on specifications of the system operation or as configured by higher layers, from a corresponding PSS and/or SSS.

In one example, the UE searches for the PSS sequence of the first pattern. In one example, the UE searches for the PSS sequence of the second pattern. In one example, the UE searches for the PSS sequence of the first pattern and the second PSS sequence of the second pattern. In one example, if the UE detects the PSS symbol of the first pattern the UE receives the symbols of the corresponding SS/PBCH Block of the first pattern within the maximum reception bandwidth of the UE. In one example, if the UE detects the PSS symbol of the second pattern the UE receives the symbols of the corresponding SS/PBCH Block of the second pattern. In one example, if the UE detects the PSS of the first pattern the UE receives the symbols of the corresponding SS/PBCH block of the first pattern within the maximum reception bandwidth of the UE and the UE determines the symbols of the associated SS/PBCH block of the second pattern, e.g., based on an offset from the first pattern or by detecting the PSS of the second pattern, and receives the symbols of the SS/PBCH block of the second pattern. In one example, the UE combines the signaling the UE receives from the SS/PBCH block of the first pattern and the associated (or corresponding) SS/PBCH block of the second pattern and decodes the combined signal.

In variant of the above examples, the SS/PBCH block (or PBCH channel or other common signal/channel) is a joint SS/PBCH block (or PBCH channel or other common signal/channel) for the first and the second SS/PBCH patterns, for example as illustrated in FIGS. 21D and 21E. In one example, the UE searches for the PSS sequence of the joint SS/PBCH block. In one example, if the UE detects the PSS of a joint SS/PBCH block, the UE receives first symbols corresponding to the first pattern within the maximum reception bandwidth of the UE, and the UE receives second symbols corresponding to the second pattern. In one example, the UE combines signaling received from the first symbols/pattern and from the second symbols/pattern, and decodes the combined signal. As aforementioned, the joint SS/PBCH block can have N_{P}+N_{S}+2N_{B} symbols. In one example, when N_{P}=N_{S}=0, the joint PBCH of the first pattern and of the second pattern is at a fixed offset, e.g., based on specifications of the system operation or as configured by higher layers, from a corresponding PSS and/or SSS.

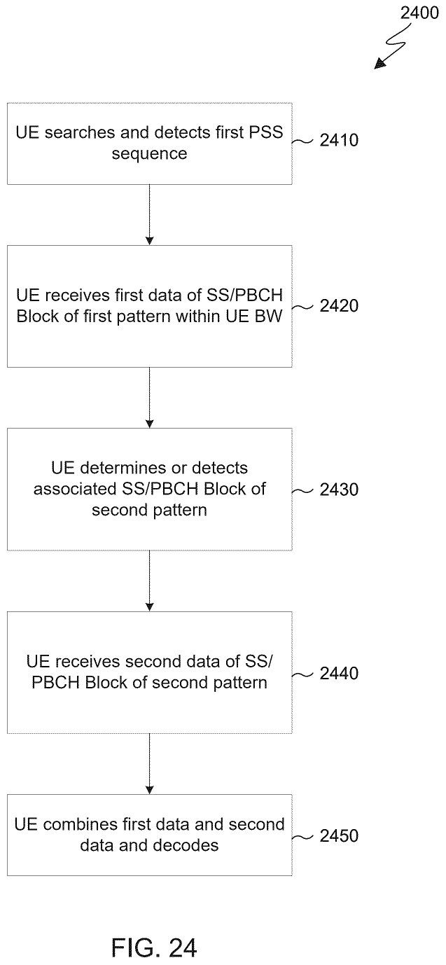

FIG. 24 illustrates an example method 2400 performed by a UE in a wireless communication system according to embodiments of the present disclosure. More particularly, the method 2400 can be performed by a low-bandwidth UE to receive SS/PBCH Blocks. The method 2400 of FIG. 24 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2400 is for illustration only and other embodiments can be used without departing from the scope of the present disclosure.

The method 2400 begins with the UE searching and detecting a first PSS sequence corresponding to a SS/PBCH block of a first pattern (2410). For example, the UE identifies the start of the SS/PBCH block of the first pattern after detecting a first PSS sequence of a PSS symbol in the SS/PBCH block of the first pattern. The UE then receives the corresponding first signaling from the SS/PBCH block of first pattern within the maximum reception BW of the UE (2420). The UE then determines or detects a SS/PBCH block of a second pattern that is associated with the detected SS/PBCH block of the first pattern (2430). In one example, the determination or detection can be based on a time offset, as described herein. In one example, the determination or detection can be based on detection of a second PSS sequences associated with the second pattern as described herein. For example, the UE identifies the start of the SS/PBCH block of the second pattern after detecting a second PSS sequence of a PSS symbol in the SS/PBCH block of the second pattern. In one example, the order of detection of the first PSS sequence and the second PSS sequence can be reversed, e.g., second PSS sequence is detected, then first PSS sequence is detected. In one example, UE simultaneously searches for both sequences and the sequence that occurs first can be detected first followed by the other sequence. In one example, there is only a first PSS sequence, the SS/PBCH block of the second pattern is at an offset from the PSS symbol of the corresponding SS/PBCH block of the first pattern. In one example, the determination or detection can be based symbols within a joint SS/PBCH block as described herein. The UE then receives the corresponding second signaling from the SS/PBCH block of the second pattern (2440). The UE then combines the first and second signaling and decodes the combined signaling to obtain information provided by the SS/PBCH block (2260).

In a variant example, with reference to FIG. 24, the location of the PBCH channel or common signal/channel of the first pattern and the PBCH channel or common signal/channel of the second pattern are known, e.g. relative to reference point for example as defined in the specifications of the system operation. The method 2400 begins with the UE receiving first signaling of a PBCH channel or common signal/channel of the first pattern within the maximum UE reception bandwidth (2420). The UE then receives second signaling of the PBCH channel or common signal/channel of the second pattern (2440) and then the UE combines the first and second signaling and decodes PBCH channel or common signal/channel (2260).

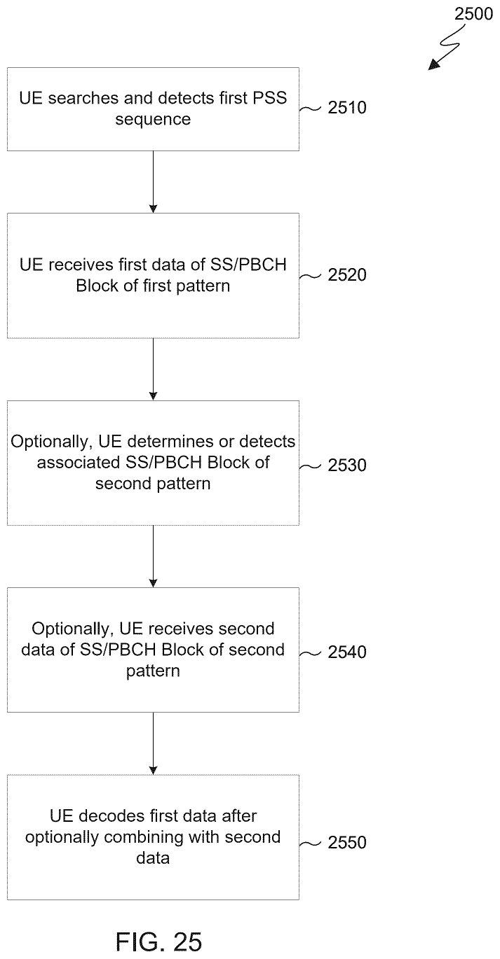

FIG. 25 illustrates an example method 2500 performed by a UE in a wireless communication system according to embodiments of the present disclosure. More particularly, the method 2500 can be performed by a high-bandwidth UE to receive SS/PBCH Blocks, wherein the network transmits an SS/PBCH block (or PBCH channel or other common signal/channel) associated with a first pattern, and an SS/PBCH block (or PBCH channel or other common signal/channel) associated with a second pattern based on examples of FIGS. 21A-21E as aforementioned. The method 2500 of FIG. 25 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2500 is for illustration only and other embodiments can be used without departing from the scope of the present disclosure.

In one example, the SS/PBCH block (or PBCH channel or other common signal/channel) associated with the first pattern has a PSS symbol with a first sequence, and the SS/PBCH block (or PBCH channel or other common signal/channel) associated with the second pattern has a PSS symbol with a second sequence for example as illustrated in FIG. 21B. In one example, the SS/PBCH block (or PBCH channel or other common signal/channel) associated with the first pattern includes a PSS symbol, and the SS/PBCH block (or PBCH channel or other common signal/channel) associated with the second pattern does not include a PSS symbol, for example as illustrated in FIG. 21C. As aforementioned, the SS/PBCH block of the first pattern, can have N_{P}+N+N_{B} symbols, and the SS/PBCH block of the second pattern can have N_{B} symbols or N_{P}+N_{B} symbols. In one example, when N_{P}=N_{S}=0, the PBCH of the first pattern and the PBCH of the second pattern is at a fixed offset, e.g., based on specifications of the system operation, from a corresponding PSS and/or SSS or as configured by higher layers.

The method 2500 begins with the UE searching and detecting the first PSS sequence (2510). For example, the UE identifies the start of the SS/PBCH block of the first pattern after detecting a first PSS sequence of a PSS symbol in the SS/PBCH block of the first pattern. In one example, when the UE detects the PSS sequence of the first pattern, the UE then receives the symbols of the corresponding SS/PBCH block of the first pattern (2520). The UE then decodes the information received in the SS/PBCH block of first pattern (2550).

In a variant example, the UE can additionally determine a SS/PBCH block of second pattern associated with the SS/PBCH block of first pattern that is detected by UE (2530), receive the SS/PBCH block of the second pattern (2540), then combine the signaling received in the SS/PBCH block of the first pattern and the signaling received in the associated or corresponding SS/PBCH block of second pattern, and decode the combined signaling to obtain the corresponding SS/PBCH block information (2550). For example, the UE identifies the start of the SS/PBCH block of the second pattern after detecting a second PSS sequence of a PSS symbol in the SS/PBCH block of the second pattern. In one example, the order of detection of the first PSS sequence and the second PSS sequence can be reversed, e.g., second PSS sequence is detected, then first PSS sequence is detected. In one example, UE simultaneously searches for both sequences and the sequence that occurs first can be detected first followed by the other sequence. In one example, there is only a first PSS sequence, the SS/PBCH block of the second pattern is at an offset from the PSS symbol of the corresponding SS/PBCH block of the first pattern.

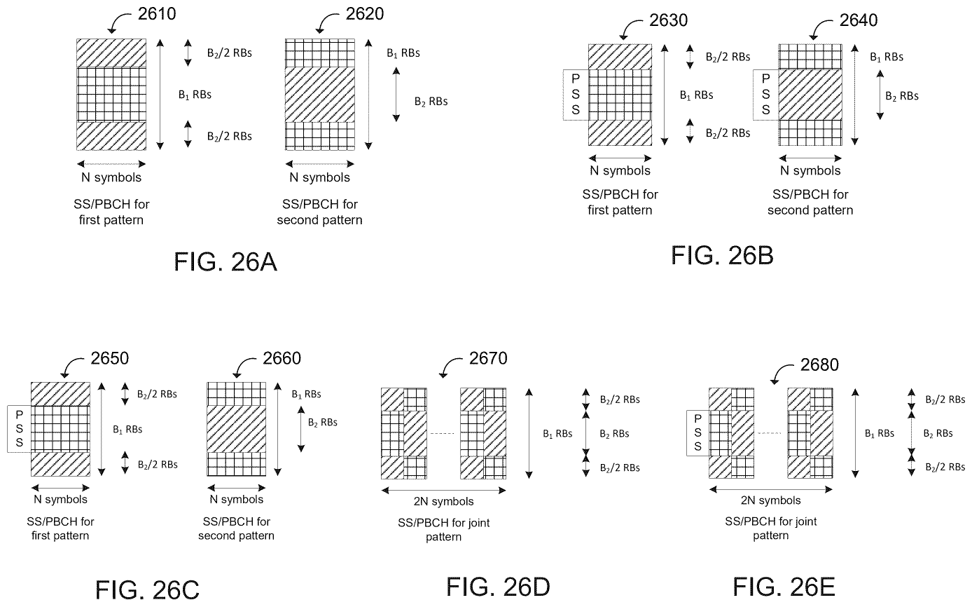

FIGS. 26A-26E illustrate example SSBs 2610-2680 (i.e., SS/PBCH blocks 2610-2680) with various patterns according to embodiments of the present disclosure. For example, SS/PBCH blocks 2610-2680 can be transmitted by BS 102 or received by any one of the UEs 111-116 of FIG. 1. These examples are for illustration only and other embodiments can be used without departing from the scope of the present disclosure.

In a variant of the aforementioned examples, as illustrated in FIG. 26A, SS/PBCH blocks 2610 and 2620 (or other common signal/channel) includes N symbols. The SS/PBCH block 2610 (or other common signal/channel) of the first pattern spans a bandwidth of B₁ RBs. The SS/PBCH block 2620 (or other common signal/channel) of the second pattern spans a bandwidth of B₁ RBs, wherein the B₂ outer RBs (RBs at the edges) of the SS/PBCH block 2610 (or common signal/channel) of the first pattern are the B₂ inner RBs (RBs closets to center) of the SS/PBCH block 2620 (or common signal/channel) of the second pattern, where B₁>B₂, and the B₁−B₂ inner RBs of the SS/PBCH Block 2610 (or common signal/channel) of the first pattern are the B₁−B₂ outer RBs of the SS/PBCH block 2620 (or common signal/channel) of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of the SS/PBCH block 2610 (or common signal/channel) of the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the SS/PBCH block 2610 (or common signal/channel) of the first pattern. In one example, B₂≈B₁/2.

In one example, as illustrated in FIG. 26B, SS/PBCH blocks 2630 and 2640 includes N+1 symbols, wherein the first symbol of the SS/PBCH block is a PSS. In one example, the PSS symbol and/or SSS symbol of SS/PBCH block 2630 of pattern 1 and the PSS symbol and/or SSS of SS/PBCH block 2640 of pattern 2 use different sequences. In one example, the PSS symbols and/or SSS symbols of the SS/PBCH block 2630 of pattern 1 and the SS/PBCH block 2640 of pattern 2 use a same sequence. The remaining N symbols of the SS/PBCH block 2630 of the first pattern span a bandwidth B₁ RBs. The remaining N symbols of the SS/PBCH block 2640 of the second pattern span a bandwidth B₁ RBs, wherein the B₂ outer RBs of the SS/PBCH Block 2630 of the first pattern are the B₂ inner RBs of the SS/PBCH Block 2640 of the second pattern, where B₁>B₂, and the B₁−B₂ inner RBs of the SS/PBCH Block 2630 of the first pattern are the B₁−B₂ outer RBs of the SS/PBCH Block 2640 of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of the SS/PBCH block 2630 of pattern 1, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the SS/PBCH block 2630 of pattern 1. In one example, B₂≈B₁/2.

In one example, an SS/PBCH block of the first pattern includes N_{P}+N_{S}+N_{B} symbols, wherein N_{P} is the number of PSS symbols, and N_{S} is the number of SSS symbols and Ng is the number of PBCH symbols. In one example, N_{P}=1. In one example, N_{S}=1. In one example, N_{P}=N_{S}=0, i.e., only PBCH symbols in the first pattern and second pattern, the PSS and SSS symbols are transmitted separately. In one example, the SS/PBCH block of the second pattern includes N_{P}+N_{B} symbols, i.e., symbols for PSS and PBCH respectively. In one example, a first sequence is used for the PSS of the first pattern, and a second sequence is used for the PSS of the second pattern. The N_{B} PBCH symbols of the first pattern span a bandwidth B₁ RBs. The N_{B} PBCH symbols of the second pattern span a bandwidth B₁ RBs, wherein the B₂ outer RBs of the PBCH symbols of the first pattern are the B₂ inner RBs of the PBCH symbols of the second pattern, where B₁>B₂, and the B₁−B₂ inner RBs of the PBCH symbols of the first pattern are the B₁−B₂ outer RBs of the PBCH symbols of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding PBCH symbol of first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding PBCH symbol of first pattern. In one example, B₂≈B₁/2.

In one example, as illustrated in FIG. 26C, an SS/PBCH block 2650 of the first pattern includes N+1 symbols, wherein the first symbol of the SS/PBCH block 2650 of the first pattern is a PSS. The SS/PBCH block 2660 of the second pattern includes N symbols. The remaining N symbols of the SS/PBCH block 2650 of the first pattern span a bandwidth B₁ RBs. The N symbols of the SS/PBCH block 2660 of the second pattern span a bandwidth B₁ RBs, wherein the B₂ outer RBs of the SS/PBCH Block 2650 of the first pattern are the B₂ inner RBs of the SS/PBCH Block 2660 of the second pattern, where B₁>B₂, and the B₁−B₂ inner RBs of the SS/PBCH Block 2650 of the first pattern are the B₁−B₂ outer RBs of the SS/PBCH block 2660 of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of the SS/PBCH block 2650 of pattern 1, and (2) the

$$\frac{{B}_{2}}{2} , the or ⌊ \frac{{B}_{2}}{2} ⌋ , or the ⌈ \frac{{B}_{2}}{2} ⌉ ,$$

respectively, upper RBs of the B₁ RBs of the corresponding symbol of the SS/PBCH block 2650 of pattern 1. In one example, B₂≈B₁/2.

In one example, an SS/PBCH block of the first pattern includes N_{P}+N_{S}+N_{B} symbols, wherein N_{P} is the number of PSS symbols, and N_{S} is the number of SSS symbols and N_{B} is the number of PBCH symbols. In one example, N_{P}=1. In one example, N_{S}=1. In one example, N_{P}=N_{S}=0, i.e., only PBCH symbols in the first pattern and second pattern, the PSS and SSS symbols are transmitted separately. In one example, the SS/PBCH block of the second pattern includes N_{B} symbols, i.e., symbols for PBCH. The N_{B} PBCH symbols of the first pattern span a bandwidth B₁ RBs. The Ng PBCH symbols of the second pattern span a bandwidth B₁ RBs, wherein the B₂ outer RBs of the PBCH symbols of the first pattern are the B₂ inner RBs of the PBCH symbols of the second pattern, where B₁>B₂, and the B₁−B₂ inner RBs of the PBCH symbols of the first pattern are the B₁−B₂ outer RBs of the PBCH symbols of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding PBCH symbol of first pattern, and (2) the

$$\frac{{B}_{2}}{2} , the or ⌊ \frac{{B}_{2}}{2} ⌋ , or the ⌈ \frac{{B}_{2}}{2} ⌉ ,$$

respectively, upper RBs of the B₁ RBs of the corresponding symbol of the SS/PBCH block of first pattern. In one example, B₂≈B₁/2.

In one example, as illustrated in FIG. 26D, a joint SS/PBCH block 2670 (or other common signal/channel) of the first pattern and the second pattern includes 2N symbols. In one example, the symbols corresponding to the first pattern are the even symbols, and the symbols corresponding to the second pattern are the odd symbols. In one example, the symbols corresponding to the first pattern are the odd symbols, and the symbols corresponding to the second pattern are the even symbols. In one example, the N symbols corresponding to the first pattern are first followed by the N symbols corresponding to the second pattern or vice versa. The N symbols corresponding to the first pattern span a bandwidth B₁ RBs. The N symbols corresponding to the second pattern span a bandwidth B₁ RBs, wherein the B₂ outer RBs of the SS/PBCH Block (or common signal/channel) of the first pattern are the B₂ inner RBs of the SS/PBCH Block (or common signal/channel) of the second pattern, where B₁>B₂, and the B₁−B₂ inner RBs of the SS/PBCH Block (or common signal/channel) of the first pattern are the B₁−B₂ outer RBs of the SS/PBCH Block (or common signal/channel) of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of N symbols corresponding to the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the N symbols corresponding to the first pattern. In one example, B₂≈B₁/2.

In one example, as illustrated in FIG. 26E, a joint SS/PBCH block 2680 of the first pattern and the second pattern includes 1+2N symbols, wherein the first symbol of the SS/PBCH block 2680 is a PSS. The remaining 2N symbols of the SS/PBCH block 2680 correspond to N symbols of the first pattern and a corresponding N symbols of the second pattern. In one example, the symbols corresponding to the first pattern are the even symbols, and the symbols corresponding to the second pattern are the odd symbols. In one example, the symbols corresponding to the first pattern are the odd symbols, and the symbols corresponding to the second pattern are the even symbols. The N symbols corresponding to the first pattern span a bandwidth B₁ RBs. The N symbols corresponding to the second pattern span a bandwidth B₁ RBs, wherein the B₂ outer RBs of the SS/PBCH block of the first pattern are the B₂ inner RBs of the SS/PBCH block of the second pattern, where B₁>B₂, and the B₁-B₂ inner RBs of the SS/PBCH block of the first pattern are the B₁−B₂ outer RBs of the SS/PBCH block of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of N symbols corresponding to the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the N symbols corresponding to the first pattern. In one example, B₂≈B₁/2.

In one example, a joint SS/PBCH block of the first pattern and the second pattern includes N_{P}+N_{S}+2N_{B} symbols, wherein N_{P} is the number of PSS symbols, and N_{S} is the number of SSS symbols and N_{B} is the number of PBCH symbols, the PBCH symbols are repeated twice once for the first pattern and once for the second pattern. In one example, N_{P}=1. In one example, N_{S}=1. In one example, N_{P}=N_{S}=0, i.e., only PBCH symbols in the first pattern and second pattern, the PSS and SSS symbols are transmitted separately. In one example, a symbol corresponding to the first pattern is first followed by a symbol corresponding to the second pattern. In one example, a symbol corresponding to the second pattern is first followed by a symbol corresponding to the first pattern. In one example, the N symbols corresponding to the first pattern are first followed by the N symbols corresponding to the second pattern or vice versa.

The N_{B} symbols of PBCH corresponding to the first pattern span a bandwidth B₁ RBs. The N_{B} symbols corresponding to the second pattern span a bandwidth B₁ RBs, wherein the B₂ outer RBs of the PBCH symbols of the first pattern are the B₂ inner RBs of the PBCH symbols of the second pattern, where B₁>B₂, and the B₁−B₂ inner RBs of the PBCH symbols of the first pattern are the B₁−B₂ outer RBs of the PBCH symbols of the second pattern (e.g., frequency hopping between the first pattern and the second pattern). In one example, the B₂ RBs are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of N symbols corresponding to the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the N_{B} symbols of PBCH corresponding to the first pattern. In one example, B₂≈B₁/2.

The N_{B} symbols of PBCH corresponding to the first pattern span a bandwidth B₁ RBs. The Ng symbols of PBCH corresponding to the second pattern span a bandwidth B₂ RBs, where B₁>B₂. In one example, the B₂ RBs of a symbol of N_{B} symbols of PBCH corresponding to the second pattern, are: (1) the

$$\frac{{B}_{2}}{2} , or the ⌈ \frac{{B}_{2}}{2} ⌉ , or the ⌊ \frac{{B}_{2}}{2} ⌋$$

lower RBs of the B₁ RBs of a corresponding symbol of N_{B} symbols of PBCH corresponding to the first pattern, and (2) the

$$\frac{{B}_{2}}{2} , or the ⌊ \frac{{B}_{2}}{2} ⌋ , or the ⌈ \frac{{B}_{2}}{2} ⌉ ,$$

respectively, upper RBs of the B₁ RBs of the corresponding symbol of the N_{B} symbols of PBCH corresponding to the first pattern. In one example, B₂≈B₁/2.

In one of the examples of FIGS. 26A-26E, the center frequency of the SS/PBCH block of the first pattern and the center frequency of the SS/PBCH block of the second pattern are the same.

In a variant of the examples of FIGS. 26A-26E, the SS/PBCH block (or other common signal/channel) of the all SS/PBCH block patterns spans B₁ RBs, and there are M SS/PBCH block (or common signal/channel) patterns. The SS/PBCH block (or common signal/channel) of the second pattern has B₂ inner RBs, . . . , the SS/PBCH block (or common signal/channel) of the M-th pattern has B_{M} inner RBs (e.g., frequency hopping between the M patterns). In one example, B₂, . . . , B_{M} are non-overlapping RBs in the B₁ RBs of the SS/PBCH block (or common signal/channel) of the first pattern. In one example, B₂, . . . , B_{M} correspond to the outer RBs of the RBs of the SS/PBCH block of the first pattern. In one example, B₂≈ . . . ≈B_{M}≈B₁/M. In one example, the center frequency of the SS/PBCH block (or common signal/channel) of each of the M patterns is the same. In one example, the B₁−(B₂+ . . . +B_{M}) inner RBs of the SS/PBCH block (or common signal/channel) of the first pattern, the B₂ inner RBs of the SS/PBCH block (or common signal/channel) of the second pattern, . . . , the B_{M} inner RBs of the SS/PBCH block (or common signal/channel) of the M-th pattern are within the maximum reception bandwidth of a low bandwidth UE. A reception of these RBs across the M SS/PBCH (or common signal/channel) patterns is equivalent to a reception of the B₁ RBs of the SS/BPCH block (or common signal/channel) of the first pattern.

In one example, PBCH payload can be encoded and rate matched in a same manner as in a first pattern and in a second pattern, but using different mapping orders and/or mapping to different REs for the first pattern and the second pattern. In one example, the PBCH payload (e.g., master information block (MIB) and other information included in the PBCH transport block) is encoded and rate matched to obtain code modulation symbols for PBCH. The coded modulation symbols are mapped in a first manner to REs of the first pattern, and are mapped in a second manner to REs of the second pattern. The mapping can be such that each coded modulation symbol for PBCH is mapped to REs within the reception bandwidth of a low-bandwidth UE in the first pattern or the second pattern as described in the examples of this disclosure.

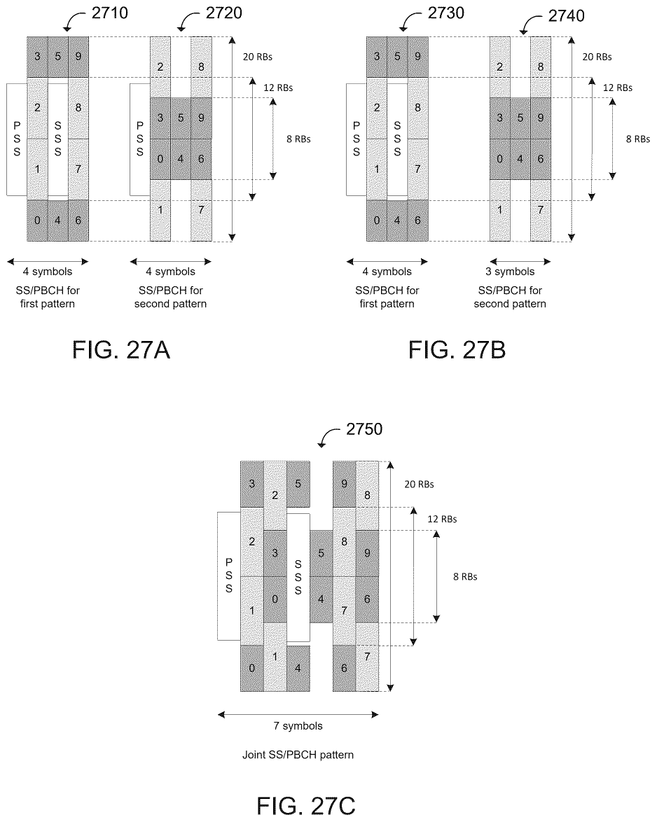

FIGS. 27A-27C illustrate alternative example SSBs 2710-2750 (i.e., SS/PBCH blocks 2710-2750) with various patterns according to embodiments of the present disclosure. For example, SS/PBCH blocks 2710-2750 can be transmitted by BS 102 or received by any one of the UEs 111-116 of FIG. 1. These examples are for illustration only and other embodiments can be used without departing from the scope of the present disclosure.

FIG. 27A illustrates an example of SS/PBCH block 2710 of a first pattern and an example of SS/PBCH block 2720 of a second pattern, where N (number of symbols in SS/PBCH block) is 4, including PSS, for each pattern. B₁=20 RBs and B₂=8 RBs. In one example, the PSS sequence of the SS/PBCH block 2710 of the first pattern and the PSS sequence of the SS/PBCH block 2720 of the second pattern are different. In one example, the PSS sequence of the SS/PBCH block 2710 of the first pattern and the PSS sequence of the SS/PBCH block 2720 of the second pattern are same.

FIG. 27B illustrates an example of SS/PBCH block 2730 of the first pattern and an example of SS/PBCH block 2740 of the second pattern, the number N of symbols of SS/PBCH block 2730 of the first pattern is 4, including PSS, the number N of symbols of SS/PBCH block 2740 of the second pattern is 3, and there is no PSS in the SS/PBCH block 2740 of the second pattern. B₁=20 RBs and B₂=8 RBs. In one example, the SS/PBCH block 2740 of second pattern starts at a time T after the end of an associated or corresponding instance of the SS/PBCH block 2730 of first pattern as described earlier.

FIG. 27C illustrates an example of a joint SS/PBCH block 2750 of the first pattern and of the second pattern, wherein the number N of symbols of joint SS/PBCH Block 2750 is 7, including a symbol for PSS. Each symbol with bandwidth B₁ (other than PSS symbol), is followed by a corresponding symbol with bandwidth B₂. B₁=20 RBs and B₂=8 RBs.

In the examples of FIG. 27A-27C, blocks with same number contain same REs.

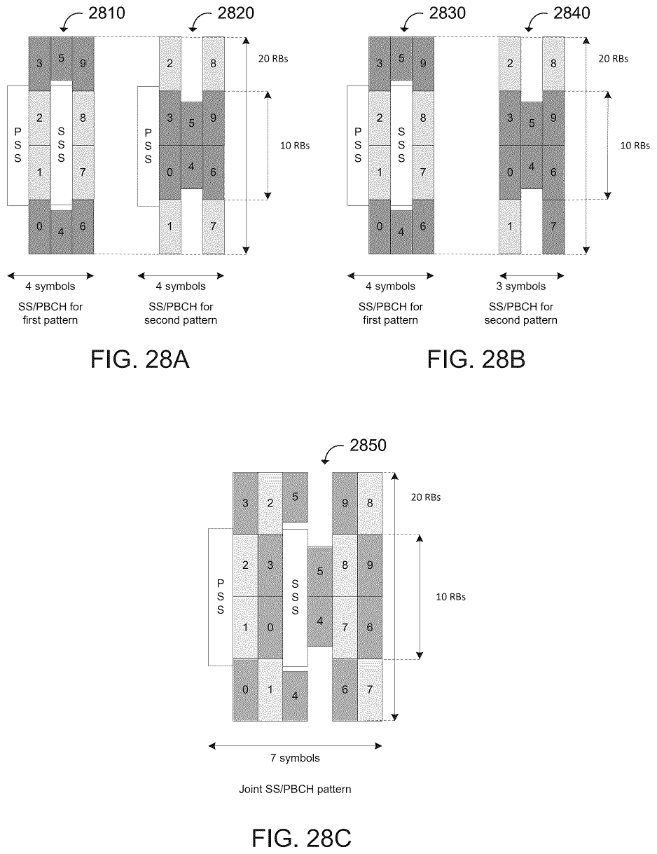

FIGS. 28A-28C illustrate more alternative example SSBs 2810-2850 (i.e., SS/PBCH blocks 2810-2850) with various patterns according to embodiments of the present disclosure. For example, SS/PBCH blocks 2710-2750 can be transmitted by BS 102 or received by any one of the UEs 111-116 of FIG. 1. These examples are for illustration only and other embodiments can be used without departing from the scope of the present disclosure.

FIG. 28A illustrates an example of a SS/PBCH block 2810 with a first pattern and an example of a SS/PBCH block 2820 with a second pattern, wherein N (number of symbols in SS/PBCH Block) is 4, including PSS, for each pattern. B₁=20 RBs and B₂=10 RBs, for the second and fourth symbols, and B₁=20 RBs and B₂=8 RBs, for the third symbol. In one example, the PSS sequence of the SS/PBCH block 2810 with the first pattern and the PSS sequence of the SS/PBCH block 2820 with the second pattern are different. In one example, the PSS sequence of the SS/PBCH block 2810 with the first pattern and the PSS sequence of the SS/PBCH block 2820 with the second pattern are same.

FIG. 28B illustrates an example of an SS/PBCH block 2830 with a first pattern and an example of an SS/PBCH block 2840 with a second pattern, wherein the number N of symbols of SS/PBCH Block 2830 of first pattern is 4, including PSS, and the number N of symbols of the SS/PBCH Block 2840 with the second pattern is 3, and there is no PSS in the SS/PBCH block 2840 with the second pattern. B₁=20 RBs and B₂=10 RBs for the second and fourth symbols of the SS/PBCH block 2830 with the first pattern and for the corresponding symbols of the SS/PBCH Block 2840 with the second pattern. B₁=20 RBs and B₂=8 RBs for the third symbol of the SS/PBCH block 2830 with the first pattern and for the corresponding symbol of the SS/PBCH block 2840 with the second pattern. In one example, the SS/PBCH block 2840 with the second pattern starts at a time T after the end of the associated or corresponding instance of the SS/PBCH block 2830 with the first pattern as described earlier.

FIG. 28C illustrates an example of a joint SS/PBCH block 2850 with the first pattern and the second pattern, wherein the number N of symbols of the joint SS/PBCH block 2850 is 7, including PSS. Each symbol with bandwidth B₁ RBs (other than PSS symbol), is followed by a corresponding symbol with bandwidth B₂ RBs. B₁=20 RBs and B₂=10 RBs for the second, third, sixth and seventh symbols. B₁=20 RBs and B₂=8 RBs for the fourth and fifth symbols.

In the examples of FIGS. 28A-28C, blocks with same number contain same REs.

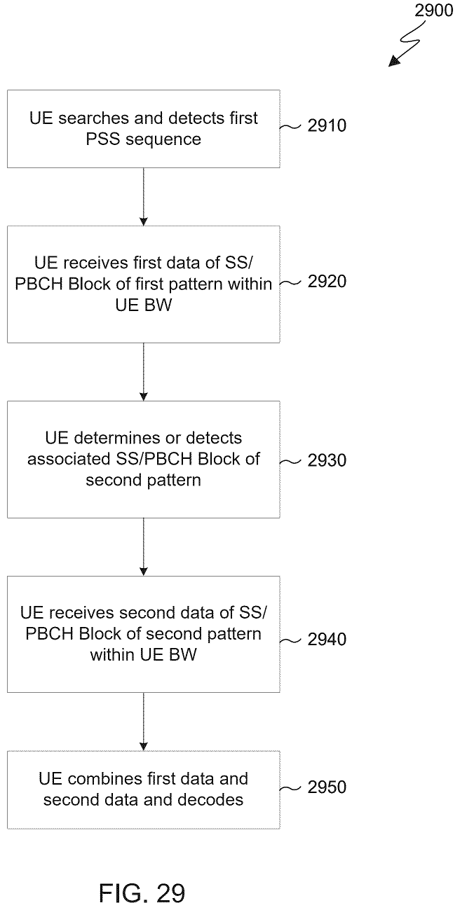

FIG. 29 illustrates an example method 2900 performed by a UE in a wireless communication system according to embodiments of the present disclosure. More particularly, the method 2900 can be performed by a low-bandwidth UE to receive SS/PBCH Blocks, wherein a network can transmit SS/PBCH Blocks (or PBCH or common signal/channel) according to a first pattern and a second pattern based on the examples of FIG. 26A-26E as aforementioned. The method 2900 of FIG. 29 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 2900 is for illustration only and other embodiments can be used without departing from the scope of the present disclosure.

The method 2900 begins with the UE searching and detecting a first PSS sequence corresponding to a SS/PBCH block with the first pattern (2910). For example, the UE identifies the start of the SS/PBCH block of the first pattern after detecting a first PSS sequence of a PSS symbol in the SS/PBCH block of the first pattern. The UE then receives the corresponding first signaling from the SS/PBCH block of the first pattern within the maximum reception BW of the UE (2920). The UE then determines or detects the SS/PBCH block with the second pattern associated with detected SS/PBCH block of the first pattern (2930). In one example, the determination or detection can be based on a time offset, as described herein. In one example, the determination or detection can be based on detection of a second PSS sequence associated with second pattern as described herein. For example, the UE identifies the start of the SS/PBCH block of the second pattern after detecting a second PSS sequence of a PSS symbol in the SS/PBCH block of the second pattern. In one example, the order of detection of the first PSS sequence and the second PSS sequence can be reversed, e.g., second PSS sequence is detected, then first PSS sequence is detected. In one example, UE simultaneously searches for both sequences and the sequence that occurs first can be detected first followed by the other sequence. In one example, there is only a first PSS sequence, the SS/PBCH block of the second pattern is at an offset from the PSS symbol of the corresponding SS/PBCH. In one example, the determination or detection can be based on symbols within a joint SS/PBCH block as described herein. The UE then receives the corresponding second signaling from the SS/PBCH block with the second pattern within the maximum reception BW of the UE (2940). The UE then combines the first and second signaling and decodes the combined signaling to obtain the SS/PBCH block information (2950).

In a variant example, with reference to FIG. 29, the location of the PBCH channel or common signal/channel with the first pattern and the PBCH channel or common signal/channel with the second pattern are known, e.g. relative to reference point, for example based on the specification of the system operation, or as configured by higher layers. The method 2900 begins with the UE receiving first signaling of PBCH channel or common signal/channel with the first pattern within the maximum UE reception bandwidth (2920). The UE then receives second signaling of PBCH channel or common signal/channel with the second pattern within the maximum UE reception bandwidth (2940) and then the UE combines the first and second signaling, and decodes the resulting PBCH channel or common signal/channel (2950). As aforementioned, the SS/PBCH block of the first pattern, can have N_{P}+N_{S}+N_{B} symbols, and the SS/PBCH block of the second pattern can have N_{B} symbols or N_{P}+N_{B} symbols. In one example, when N_{P}=N_{S}=0, the PBCH of the first pattern and the PBCH of the second pattern is at a fixed offset, e.g., based on specifications of the system operation or as configured by higher layers, from a corresponding PSS and/or SSS. As aforementioned, the joint SS/PBCH block can have N_{P}+N_{S}+2N_{B} symbols. In one example, when N_{P}=N_{S}=0, the joint PBCH of the first pattern and of the second pattern is at a fixed offset, e.g., based on specifications of the system operation or as configured by higher layers, from a corresponding PSS and/or SSS.

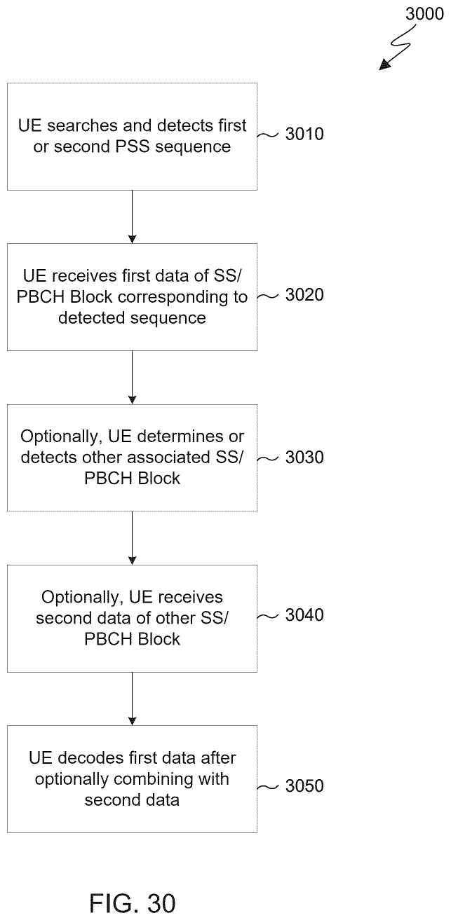

FIG. 30 illustrates an example method 3000 performed by a UE in a wireless communication system according to embodiments of the present disclosure. More particularly, the method 3000 can be performed by a high-bandwidth UE to receive SS/PBCH Blocks, wherein a network can transmit SS/PBCH blocks according to a first pattern and a second pattern based on the examples of FIGS. 26A-26E as aforementioned. The method 3000 of FIG. 30 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3000 is for illustration only and other embodiments can be used without departing from the scope of the present disclosure.

In one example, the method 3000 begins with the UE searching and detecting a first PSS sequence corresponding to a SS/PBCH block with the first pattern (3010). For example, the UE identifies the start of the SS/PBCH block of the first pattern after detecting a first PSS sequence of a PSS symbol in the SS/PBCH block of the first pattern. The UE then receives corresponding first signaling from the SS/PBCH block with the first pattern (3020). The UE then decodes first information from the first signaling to obtain SS/PBCH block information (3050).

In one example, the method 3000 begins with the UE searching first or second PSS sequence corresponding to a SS/PBCH block with the first pattern or to a SS/PBCH block with the second pattern respectively (3010). The UE then detects one of the sequences (3010). The UE then receives corresponding signaling from the SS/PBCH block corresponding to the detected sequence (3020). The UE then decodes the information from the signaling to obtain SS/PBCH block information (3050). For example, the UE identifies the start of the SS/PBCH block of the first pattern after detecting a first PSS sequence of a PSS symbol in the SS/PBCH block of the first pattern, and the UE identifies the start of the SS/PBCH block of the second pattern after detecting a second PSS sequence of a PSS symbol in the SS/PBCH block of the second pattern. In one example, the first PSS sequence is detected, then the second PSS sequence is detected. In one example, the order of detection of the first PSS sequence and the second PSS sequence can be reversed, e.g., second PSS sequence is detected, then first PSS sequence is detected. In one example, UE simultaneously searches for both sequences and the sequence that occurs first can be detected first followed by the other sequence.

In one example, the method 3000 begins with the UE searching and detecting a first PSS sequence corresponding to a SS/PBCH block with the first pattern (3010). The UE then receives first signaling from the SS/PBCH block with the first pattern (3020). The UE then determines or detects SS/PBCH block with the second pattern that is associated with the detected SS/PBCH block with the first pattern (3030). In one example, the determination or detection can be based on a time offset, as described herein. In one example, the determination or detection can be based on detection of a second PSS sequence associated with the second pattern as described herein. In one example, the determination or detection can be based on symbols within a joint SS/PBCH block as described herein. The UE then receives second signaling from the SS/PBCH block with the second pattern (3040). The UE then combines the first and second signaling and decodes the information in the combined signaling to obtain the SS/PBCH block information (3050).

In a variant example, the location of the PBCH channel or common signal/channel with the first pattern and the PBCH channel or common signal/channel with the second pattern are known, e.g. relative to reference point, for example based on the specifications of the system operation or as configured by higher layers. The method 3000 begins with the UE receiving first signaling for the PBCH channel or common signal/channel with the first pattern (3020), and/or receiving second signaling for the PBCH channel or common signal/channel with the second pattern (3040), and optionally combines the first and second signaling and decodes the combined PBCH channel or common signal/channel, or decodes the PBCH channel or common channel/signal based on one of the first signaling or the second signaling (3050). As aforementioned, the SS/PBCH block of the first pattern, can have N_{P}+N_{S}+N_{B} symbols, and the SS/PBCH block of the second pattern can have N_{B} symbols or N_{P}+N_{B} symbols. In one example, when N_{P}=N_{S}=0, the PBCH of the first pattern and the PBCH of the second pattern is at a fixed offset, e.g., based on specifications of the system operation or as configured by higher layers, from a corresponding PSS and/or SSS. As aforementioned, the joint SS/PBCH block can have N_{P}+N_{S}+2N_{B} symbols. In one example, when N_{P}=N_{S}=0, the joint PBCH of the first pattern and of the second pattern is at a fixed offset, e.g., based on specifications of the system operation or as configured by higher layers, from a corresponding PSS and/or SSS.

As aforementioned, the examples of this disclosure can apply to other common signals/channels with bandwidth larger than bandwidth of low-bandwidth UE.

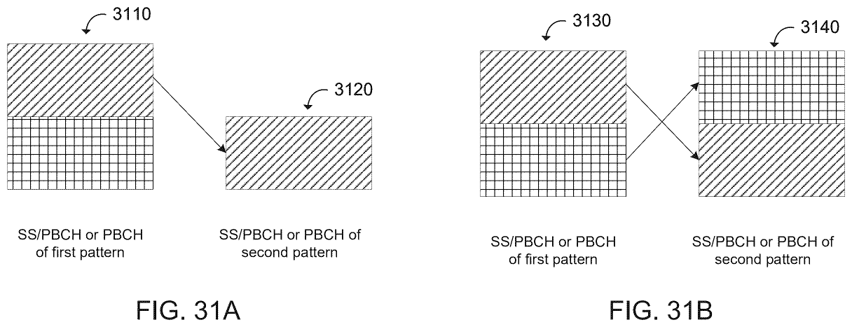

FIGS. 31A and 31B illustrate example SSBs 3110-3140 (i.e., SS/PBCH blocks 3110-3140) that can utilize replacement bands according to embodiments of the present disclosure. For example, SS/PBCH blocks 3110-3140 can be transmitted by BS 102 or received by any one of the UEs 111-116 of FIG. 1. These examples are for illustration only and other embodiments can be used without departing from the scope of the present disclosure.

In a variant example, as illustrated in FIGS. 31A and 31B the inner band and outer band of a SS/PBCH block or common channel or signal can be replaced by the upper band and lower band of another SS/PBCH block or common channel or signal. In FIG. 31A, the SS/PBCH block 3110 or PBCH channel of the first pattern includes the full signal, while the SS/PBCH block 3120 or PBCH channel of the second pattern includes the upper half (or lower half) of the SS/PBCH block 3110 or PBCH channel of first pattern moved to the lower half (or upper half respectively). A low bandwidth UE with reception bandwidth equal to (or larger than) the lower half (or upper half respectively), receives the lower half (or upper half respectively) of both the first and the second patterns, thus receiving all the REs of the SS/PBCH or PBCH channel. In FIG. 31B, the SS/PBCH block 3130 or PBCH channel of the first pattern and the SS/PBCH block 3140 or PBCH channel of the second pattern include the full signal, but with the upper and lower halves reversed. A low bandwidth UE with reception bandwidth equal to (or larger than) the lower half (or upper half), receives the lower half (or upper half respectively) of both the first and the second patterns, thus receiving all the REs of the SS/PBCH or PBCH channel. In one example, the number of patterns and corresponding number of bandwidth parts can be M (in the examples of FIGS. 31A and 31B, M-2). The examples of this disclosure apply to FIGS. 31A and 31B.

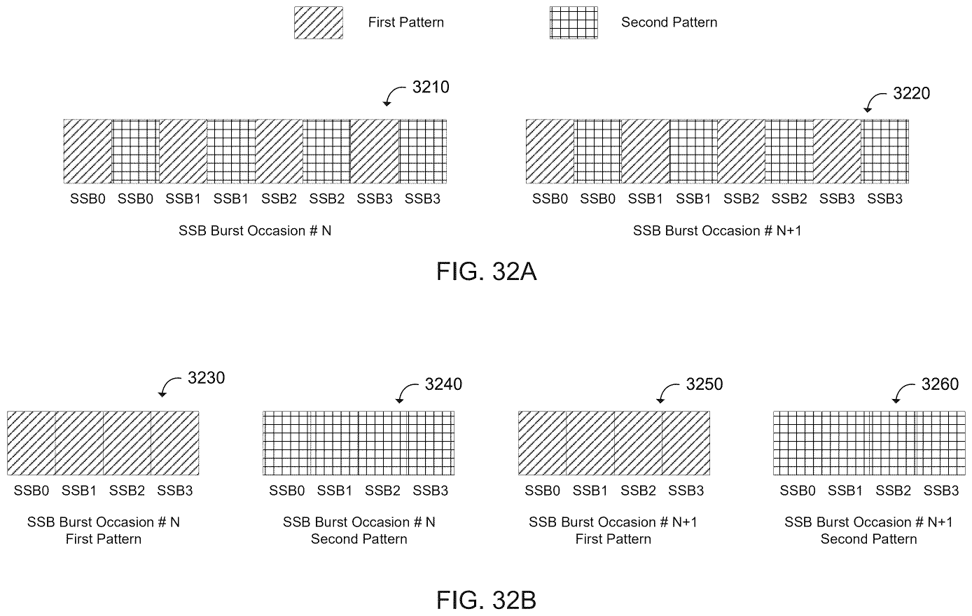

FIGS. 32A and 32B illustrate example SSBs 3210-3260 (i.e., SS/PBCH blocks 3210-3260) that are organized in bursts according to embodiments of the present disclosure. For example, SS/PBCH blocks 3210-3260 can be transmitted by BS 102 or received by any one of the UEs 111-116 of FIG. 1. These examples are for illustration only and other embodiments can be used without departing from the scope of the present disclosure.

As illustrated in FIGS. 32A and 32B, SSBs 3210-3260 are organized in bursts of up to N SSBs, each SSB within a burst has an index i, where i=0, 1, . . . , N−1. In one example, each SSB with index i is transmitted using the first pattern and using the second pattern. In one example, the first pattern and the second pattern are interleaved across the SSB bursts as illustrated in FIG. 32A. In one example, an SSB burst of the first pattern is transmitted followed by an SSB burst of a second pattern as illustrated in FIG. 32B.

According to the examples of this disclosure a gNB transmits SS/PBCH block or PBCH channel or other common channel or signal of a first pattern, and SS/PBCH block or PBCH channel or other common channel or signal of a second pattern. In one example, the SS/PBCH block or PBCH channel or other common channel or signal of the first pattern and of the second pattern are transmitted in bursts. In various embodiments, each burst includes up to N instances of SS/PBCH blocks or PBCH channel or other common channel or signal of the first pattern and a corresponding up to N instances of SS/PBCH blocks or PBCH channel or other common channel or signal of the second pattern. The N instances of the first pattern can be interleaved within a burst as illustrated in FIG. 32A or can be transmitted for one burst of a first pattern followed by a corresponding burst of the second pattern as illustrated in FIG. 32 B.

For each instance of the first pattern and the corresponding instance of the second pattern coded modulation symbols are obtained by encoding and rate matching of the information to be transmitted. The mapping of the coded modulation symbols to resource elements (REs) of the first pattern and the second pattern is such that each/a coded modulation symbol is mapped to REs within the reception bandwidth of a low-bandwidth UE in the first pattern or the second pattern as described in the examples of this disclosure.

A low bandwidth UE receiving the SS/PBCH block or PBCH channel or other common channel or signal receives REs within the low bandwidth UE reception bandwidth from the first pattern and corresponding instances of the second pattern the REs are combined (e.g., to get the full set of REs of the SS/PBCH block or PBCH channel or other common channel or signal). In one example, to identify an instance of the first pattern and a corresponding instance of the second pattern, a symbol(s) with a first sequence(s) (e.g., PSS/SSS symbol with first PSS/SSS sequence) is associated with the first pattern or included in an instance of the first pattern and a symbol(s) with a second sequence(s) (e.g., PSS/SSS symbol with second PSS/SSS sequence) is associated with the second pattern or included in a corresponding instance of the second pattern. The UE searches and detects the first sequence and the second sequence. Alternatively, or additionally, an instance of a first pattern is followed or proceeded by a corresponding instance of a second pattern, for example, a UE determines an instance of a first pattern, e.g., by searching and detecting a sequence e.g., a PSS/SSS sequence, the corresponding instance of the second pattern is then determined based on an offset.

After the UE receives the REs of the first instance and the corresponding second instance, the UE can have the full set of REs of the SS/PBCH block or PBCH channel or other common channel or signal, the UE decodes the received signal and obtains the corresponding decoded information. In one example, when the first pattern and the second pattern have corresponding bursts of N instances, the UE searches and identifies an instance of the N instances and decodes the data corresponding to the identified instance. In the examples mentioned herein, a first pattern and second pattern of a channel or signal can be replaced by a first part or a second part of a channel or signal.

In the examples of this disclosure, the first pattern and the second pattern can have a same spatial domain filter or a same quasi-co-location (QCL) information or a same spatial relation or a same TCI state.

Alternatively, in the examples of this disclosure, the first pattern and the second pattern can have different spatial domain filters or QCL information or different spatial relations or different TCI states. For example, the first pattern can have a first spatial domain filter/QCL information/spatial relation/TCI state (e.g., corresponding to a wide beam), and the second pattern can have a second spatial domain filter/QCL information/spatial relation/TCI state (e.g., corresponding to a narrow or refined beam of the wide beam). In some examples, the second pattern can be transmitted multiple times using multiple second spatial domain filters/QCL information/spatial relations/TCI states respectively. In one example, the first and second spatial domain filters/QCL information/spatial relations/TCI states are related by a mapping (e.g., based on configuration). In one example, the roles of the first and second patterns are reversed.

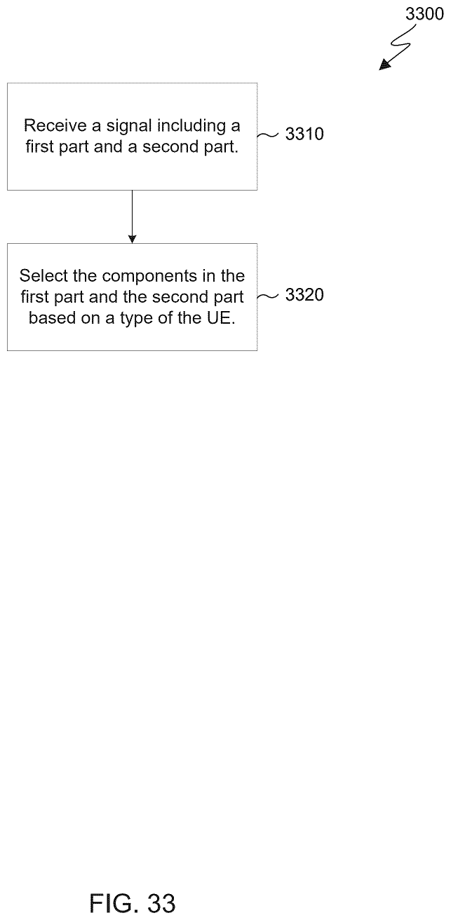

FIG. 33 illustrates an example method 3300 performed by UE in a wireless communication system according to embodiments of the present disclosure. The method 3300 of FIG. 33 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 3300 is for illustration only and other embodiments can be used without departing from the scope of the present disclosure.

The method 3300 begins with the UE receiving a signal including a first part and a second part (3310). For example, in 3310, the first part is within a bandwidth 2*B, where B is a positive value. The first part includes components B1, B2, B3 and B4, such that, in a frequency domain, the components B1 and B4 are at lower and higher frequencies, respectively, relative to the components B2 and B3 in the first part and the components B2 and B3 are within a bandwidth B. The seconds part includes at least the components B1 and B4. The components B1 and B4 in the second part are within the bandwidth B in the frequency domain.

The UE then selects the components in the first part and the second part based on a type of the UE (3320), e.g., based on whether the UE is a high-bandwidth UE or low-bandwidth UE. In various embodiments, the UE, when the type of the UE is a first type (e.g., high-bandwidth UE), selects the components B1, B2, B3 and B4 in the first part and at least the components B1 and B4 in the second part. When the type of the UE is a second type (e.g., low-bandwidth UE), the UE selects the components B2 and B3 in the first part and the components B1 and B4 in the second part.

In various embodiments, the second part further includes the components B2 and B3, and in the frequency domain, the components B2 and B3 are at lower and higher frequencies, respectively, relative to the components B1 and B4 in the second part.

In various embodiments, the first part and the second part separated by a time T from a start of the first part to a start of the second part. In other embodiments, the second part directly follows the first part without a time gap between the first and second parts.

In various embodiments, the first part includes N symbols, where N is a positive integer, the second part includes N symbols. The symbols of the first part and the second part are interleaved such that a symbol of the first part is followed by a corresponding symbol of the second part.

In various embodiments, the first part is associated with a first sequence transmitted at a start of the first part. The second part is associated with a second sequence transmitted at a start of the second part.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE) comprising:
a transceiver configured to receive a signal including a first part and a second part, wherein:
the first part is within a bandwidth 2*B, where B is a positive value,
the first part includes components: B1, B2, B3 and B4, such that, in a frequency domain:
the components B1 and B4 are at lower and higher frequencies, respectively, relative to the components B2 and B3 in the first part, and
the components B2 and B3 are within a bandwidth B,
the seconds part includes at least the components B1 and B4, and
the components B1 and B4 in the second part are within the bandwidth B in the frequency domain; and
a processor operably coupled to the transceiver, the processor configured to select, based on a type of the UE, the components in the first part and the second part.

2. The UE claim of 1, wherein:
the second part further includes the components B2 and B3, and
in the frequency domain, the components B2 and B3 are at lower and higher frequencies, respectively, relative to the components B1 and B4 in the second part.

3. The UE of claim 1, wherein the first part and the second part separated by a time T from a start of the first part to a start of the second part.

4. The UE of claim 1, wherein the second part directly follows the first part without a time gap between the first and second parts.

5. The UE of claim 1, wherein:
the first part includes N symbols, where N is a positive integer,
the second part includes N symbols, and
the symbols of the first part and the second part are interleaved such that a symbol of the first part is followed by a corresponding symbol of the second part.

6. The UE of claim 1, wherein:
the first part is associated with a first sequence transmitted at a start of the first part, and
the second part is associated with a second sequence transmitted at a start of the second part.

7. The UE of claim 1, wherein the processor is further configured to:
when the type of the UE is a first type, select the components B1, B2, B3 and B4 in the first part and at least the components B1 and B4 in the second part, and
when the type of the UE is a second type, select the components B2 and B3 in the first part and the components B1 and B4 in the second part.

8. A base station (BS) comprising:
a processor, and
a transceiver operably coupled to the processor, the transceiver configured to transmit a signal including a first part and a second part, wherein:
the first part is within a bandwidth 2*B, where B is a positive value,
the first part includes components: B1, B2, B3 and B4, such that, in a frequency domain:
the components B1 and B4 are at lower and higher frequencies, respectively, relative to the components B2 and B3 in the first part, and
the components B2 and B3 are within a bandwidth B,
the seconds part includes at least the components B1 and B4, and
the components B1 and B4 in the second part are within the bandwidth B in the frequency domain.

9. The BS claim of 8, wherein:
the second part further includes the components B2 and B3, and
in the frequency domain, the components B2 and B3 are at lower and higher frequencies, respectively, relative to the components B1 and B4 in the second part.

10. The BS of claim 8, wherein the first part and the second part separated by a time T from a start of the first part to a start of the second part.

11. The BS of claim 8, wherein the second part directly follows the first part without a time gap between the first and second parts.

12. The BS of claim 8, wherein:
the first part includes N symbols, where N is a positive integer,
the second part includes N symbols, and
the symbols of the first part and the second part are interleaved such that a symbol of the first part is followed by a corresponding symbol of the second part.

13. The BS of claim 8, wherein:
the first part is associated with a first sequence transmitted at a start of the first part, and
the second part is associated with a second sequence transmitted at a start of the second part.

14. A method of operating a user equipment (UE), the method comprising:
receiving a signal including a first part and a second part, wherein:
the first part is within a bandwidth 2*B, where B is a positive value,
the first part includes components: B1, B2, B3 and B4, such that, in a frequency domain:
the components B1 and B4 are at lower and higher frequencies, respectively, relative to the components B2 and B3 in the first part, and
the components B2 and B3 are within a bandwidth B,
the seconds part includes at least the components B1 and B4, and
the components B1 and B4 in the second part are within the bandwidth B in the frequency domain; and
selecting, based on a type of the UE, the components in the first part and the second part.

15. The method of claim of 14, wherein:
the second part further includes the components B2 and B3, and
in the frequency domain, the components B2 and B3 are at lower and higher frequencies, respectively, relative to the components B1 and B4 in the second part.

16. The method of claim 14, wherein the first part and the second part separated by a time T from a start of the first part to a start of the second part.

17. The method of claim 14, wherein the second part directly follows the first part without a time gap between the first and second parts.

18. The method of claim 14, wherein:
the first part includes N symbols, where Nis a positive integer,
the second part includes N symbols, and
the symbols of the first part and the second part are interleaved such that a symbol of the first part is followed by a corresponding symbol of the second part.

19. The method of claim 14, wherein:
the first part is associated with a first sequence transmitted at a start of the first part, and
the second part is associated with a second sequence transmitted at a start of the second part.

20. The method of claim 14, further comprising:
when the type of the UE is a first type, selecting the components B1, B2, B3 and B4 in the first part and at least the components B1 and B4 in the second part, and
when the type of the UE is a second type, selecting the components B2 and B3 in the first part and the components B1 and B4 in the second part.
